(19) United States
(12) Patent Application Publication
(10) Pub. No.: US 2025/0039044 A1
(43) Pub. Date: Jan. 30, 2025

(54) RECONFIGURABLE CONFIGURATIONS AND TEMPLATE CONFIGURATIONS FOR NETWORK DEVICES OF A WIRELESS COMMUNICATION NETWORK

(71) Applicant: Fraunhofer-Gesellschaft zur Förderung der angewandten Forschung e.V., München (DE)

(72) Inventors: Thomas HAUSTEIN, Berlin (DE); Lars THIELE, Berlin (DE); Jasmina MCMENAMY, Berlin (DE)

(21) Appl. No.: 18/790,190

(22) Filed: Jul. 31, 2024

Related U.S. Application Data
(63) Continuation of application No. PCT/EP2023/051555, filed on Jan. 23, 2023.

(30) Foreign Application Priority Data
Jan. 31, 2022 (EP) 22154288.9

(51) Int. Cl. H04L 41/0816; H04B 17/318; H04B 17/336; H04L 41/084; H04W 24/02; H04W 24/10; H04W 76/28

(52) U.S. Cl. CPC H04L 41/0816; H04B 17/328; H04B 17/336; H04L 41/0843; H04W 24/02; H04W 24/10; H04W 76/28

(57) ABSTRACT

A user device, UE, for a wireless communication system, like a 3^{rd} Generation Partnership Project, 3GPP, system, is described. The UE includes one or more antennas, a signal processor connected to the antenna, and one or more configurations. The configuration is associated with one or more certain operations to be performed by the signal processor, defines one or more fields concerning the certain operation, and includes for each field one or more field values to be applied or used by the UE when performing the certain operation. The UE operates in accordance with the configuration, and generates a new configuration by modifying the configuration by replacing the field value for a field in the configuration by a new field value.

### CROSS-REFERENCE TO RELATED APPLICATIONS

This application is a continuation of copending International Application No. PCT/EP2023/051555, filed Jan. 23, 2023, which is incorporated herein by reference in its entirety, and additionally claims priority from European Application No. 22154288.9, filed Jan. 31, 2022, which is also incorporated herein by reference in its entirety.

### TECHNICAL FIELD

The present invention relates to the field of wireless communication systems or networks, more specifically to the configuration and/or reconfiguration of a user device in a wireless communication network. Embodiments relate to one or more UE configurations having one or more field, wherein field values of the fields may be modified or changed without the need for providing a complete new UE configuration, or wherein fields from several UE configurations may be combined into a new UE configuration. Other embodiments relate to one or more template configurations that may be provided for a UE, wherein a template configuration may be populated with respective field values at a certain time following the provisioning of the UE with the template, or wherein fields from several template configurations may be combined into a new template configuration.

### BACKGROUND OF THE INVENTION

FIG. 1(A) and FIG. 1(B) schematically illustrate an example of a terrestrial wireless network 100 including, as is shown in FIG. 1(A), the core network 102 and one or more radio access networks RAN₁, RAN₂, . . . . RAN_{N}. FIG. 1(B) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANₙ may include more or less such cells, and RANₙ may also include only one base station. FIG. 1(B) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1(A) and FIG. 1(B) may be a heterogeneous network having distinct overlaid networks, e.g., a network of macro cells with each macro cell including a macro base station, like base station gNB₁ to gNB₅, and a network of small cell base stations, not shown in FIG. 1(A) and FIG. 1(B), like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1(A) and FIG. 1(B), for example in accordance with the LTE-Advanced Pro standard or the 5G or NR, new radio, standard.

In mobile communication networks, for example in a network like that described above with reference to FIG. 1(A) and FIG. 1(B), like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1(A) and FIG. 1(B). This is referred to as an “in-coverage” scenario. Another scenario is referred to as an “out-of-coverage” scenario. It is noted that “out-of-coverage” does not mean that the two UEs are necessarily outside one of the cells depicted in FIG. 1(A) and FIG. 1(B), rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

In a wireless communication system as described above with reference to FIG. 1(A) and FIG. 1(B), for example, the radio resource control, RRC, protocol may be used on the air interface which is a layer 3 protocol between a user device, UE, and a gNB or base station. By means of the RRC protocol, certain functions may be implemented, like a connection establishment and release functions, a broadcast of system information, an establishment of a radio bearer, a reconfiguration and release, connection mobility procedures, a paging notification and the like. The RRC allows configuring the user or UE in control planes according to the network status and also allows for implementing certain RRC management strategies.

It is noted that the information in the above section is only for enhancing the understanding of the background of the invention and, therefore, it may contain information that does not form known technology that is already known to a person of ordinary skill in the art.

In view of the above-described known technology, there remains a need for enhancements and/or improvements regarding the configuration of a user device in a wireless communication network using, for example, the RRC protocol.

### SUMMARY

According to an embodiment, a user device, UE, for a wireless communication system, like a 3^{rd} Generation Partnership Project, 3GPP, system, may have: one or more antennas, a signal processor connected to the antenna, and one or more configurations, wherein the configuration
is associated with one or more certain operations to be performed by the signal processor, defines one or more fields concerning the certain operation, and
includes for each field one or more field values to be applied or used by the UE when performing the certain operation,
wherein the UE is to operate in accordance with the configuration, and wherein the UE is to generate a new configuration by modifying the configuration by replacing the field value for a field in the configuration by a new field value.

According to another embodiment, a user device, UE, for a wireless communication system, like a 3rd Generation Partnership Project, 3GPP, system, may have: one or more antennas, a signal processor connected to the antenna, and one or more configuration templates, wherein the configuration template is associated with one or more certain operations to be performed by the signal processor,
defines one or more fields concerning the certain operation, and
includes for one, some or all fields a placeholder for one or more field values,
wherein the UE is to generate a configuration for performing the certain operation by replacing in the configuration template the placeholder for a field by a field value.

According to another embodiment, a method for operating a user device, UE, for a wireless communication system, like a 3rd Generation Partnership Project, 3GPP, system, the UE having one or more antennas, a signal processor connected to the antenna, and one or more configurations, wherein the configuration
is associated with one or more certain operations to be performed by the signal processor,
defines one or more fields concerning the certain operation, and
includes for each field one or more field values to be applied or used by the UE when performing the certain operation,
may have the steps of: operating the UE in accordance with the configuration, and generating, by the UE, a new configuration by modifying the configuration by replacing the field value for a field in the configuration by a new field value.

According to another embodiment, a method for operating a user device, UE, for a wireless communication system, like a 3rd Generation Partnership Project, 3GPP, system, the UE having one or more antennas, a signal processor connected to the antenna, and one or more configuration templates, wherein the configuration template
is associated with one or more certain operations to be performed by the signal processor,
defines one or more fields concerning the certain operation, and
includes for one, some or all fields a placeholder for one or more field values,
may have the step of: generating, by the UE, a configuration for performing the certain operation by replacing in the configuration template the placeholder for a field by a field value.

### BRIEF DESCRIPTION OF THE DRAWINGS

Embodiments of the present invention are now described in further detail with reference to the accompanying drawings, in which:

FIG. 1(A) and FIG. 1(B) schematically illustrate an example of a terrestrial wireless network;

FIG. 2 illustrates an example of an RRCReconfig message;

FIG. 3 illustrates an example of a CSI-MeasConfig information element, IE, used to configure CSI Resources Signals, CSI-RSs to be measured;

FIG. 4(A) to FIG. 4(C) illustrate an example of a CSI-ReportConfig information element, IE, used to configure a periodic or semi-persistent report;

FIG. 5 illustrates an example of setting up of CSI resources and a reporting configuration via an AddModList in a CSI-MeasConfig IE;

FIG. 6 illustrates an example of an ASN.1 that provides an elements ToAddModList and an elements ToReleaseList;

FIG. 7 illustrates an example of a link between CSI resources fields in a CSI-ReportConfig IE and a CSI-ResourceConfig IE;

FIG. 8 illustrates an example of a CSI reporting configuration and reporting IE;

FIG. 9 summarizes the possibilities for configuring, for example, a physical layer using RRC, MAC CE and DCI;

FIG. 10 illustrates a user device, UE, in accordance with embodiments of the present invention, and a network entity in accordance with embodiments of the present invention;

FIG. 11 illustrates an embodiment of a user device in accordance with embodiments of the first aspect of the present invention;

FIG. 12(A) to FIG. 12(C) illustrate examples of modifying an existing UE configuration or IE in accordance with a first embodiment of the first aspect of the present invention;

FIG. 13 illustrates changing a field value for a certain field of a configuration using lower layer signaling in accordance with embodiments of the first aspect of the present invention;

FIG. 14 illustrates an example for creating a new UE configuration in accordance with a second embodiment of the first aspect of the present invention;

FIG. 15 illustrates an example for populating a template in accordance with a first embodiment of the second aspect of the present invention;

FIG. 16 illustrates an example for combining configuration templates in accordance with a second embodiment of the second aspect of the present invention;

FIG. 17(A) to FIG. 17(C) illustrate in more detail examples for configuring a UE with templates in accordance with embodiments of the second aspect of the present invention;

FIG. 18 illustrates a communication between a gNB and a UE in accordance with embodiments of the second aspect of the present invention; and

FIG. 19 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

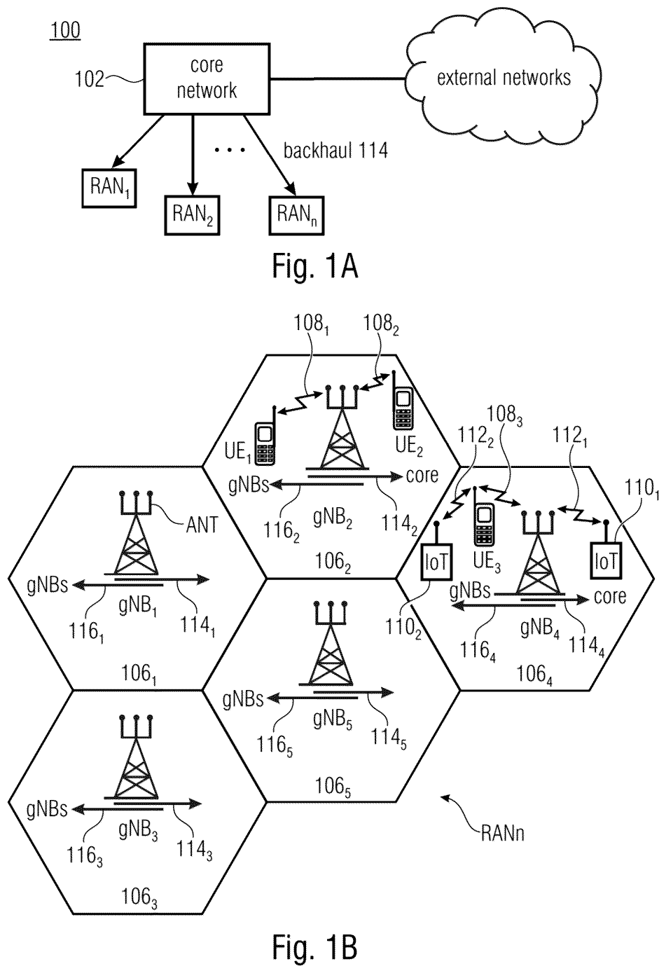

In a wireless communication system or network, like the one described above with reference to FIG. 1(A) and FIG. 1(B), which, for example, may be a 5G or NR wireless communication network, the NR technology provides a great level of flexibility, including aspects such as flexible numerology and variable subcarrier spacing, the use of different bandwidth parts, BWPs, a highly granular scheduling, flexible time division duplex, TTD, slots or symbols and the like. Such flexibility, coupled with the highly directional, multiple-antenna base communication, may entail a complex physical layer configuration structure. Such a structure may be supported by different signaling mechanisms which operate at different levels of the protocol stack. At the core of this structure is the above-mentioned radio resource control, RRC, protocol, which is responsible for configuring and/or controlling the radio resources between the UE and the base station or gNB. The RRC protocol is a layer 3, L3, protocol and its connection control function may include radio configuration control and measurement configuration and reporting, as described, for example, in section 4.4 of Reference [1]. The RRC protocol may be responsible for configuring the packet data convergence protocol, PDCP, layer, the radio link control, RLC, layer, the media access control, MAC, layer and the physical, PHY, layer. RRC packet data units, PDUs, are described using the abstract syntax notation one, ASN.1, packet encoding rules as described, for example, in sections 6 and 8 of Reference [1].

Conventionally, a user device, UE, has one or more configurations, also referred to in the following as UE configurations. The UE may be configured or preconfigured with the UE configurations. To provide for the above-mentioned flexibility, during operation, the UE may be configured or reconfigured by the wireless communication system by sending a configuration or reconfiguration message over the air interface including a new UE configuration to be employed by the UE for performing a certain function or operation. In the present application, this is also referred to as a UE being configured with a UE configuration. Thus, by means of the RRC protocol, the network may configure a UE to perform certain operations of functions, e.g., to perform measurements and report them in accordance with a certain measurement configuration which, in turn, is provided by dedicated signaling, like an RRC reconfiguration message. For example, the UE may perform intra-frequency NR measurements, inter-frequency NR measurements, and/or inter-radio access technology, RAT, measurements.

### Measurement and Reporting Through IE Examples

In the following, the configuration of a UE to perform measurements and report them are discussed in more detail as an example of a conventional approach for configuring a UE by means of a measurement configuration.

As mentioned above, the RRC protocol may be defined using platform agnostic Abstract Syntax Notation One, ASN.1 (see Annex A of reference [1]). The structures used by RRC may be in general divided into two types: messages and Information Elements, IEs. Messages are the structures which are sent between the UE and the gNB and they in turn contain many fields or parameters, which are defined using Information Element structures (see reference [2]). Each RRC message may be comprised of structured data types (SEQUENCE, SEQUENCE OF, CHOICE) and simple data types (BOOLEAN, INTEGER, ENUMERATED, BIT STRING and OCTET STRING). Each structured data type may further be comprised of structured and simple data types. According to the RRC definition, a structural element containing single or multiple fields is referred as information element. The individual contents of an information element are referred to as fields. An example of an RRC message may be as follows:

| -- /example/ ASN1START | |
|---|---|
| RRCMessage-r8-IEs ::= SEQUENCE { | |
| field1 | InformationElement1, |
| field2 | InformationElement2, |

noncritical Extension SEQUENCE { } OPTIONAL
}
-- ASN1STOP

According to reference [1], a group of closely related IE type definitions are advantageously placed together in a common ASN.1 section. The IE type identifiers, i.e., names have a common base, such as PRACH-Config in the example below, defined as the generic type identifier. It may be complemented by a suffix to distinguish different variants (the “SIB” suffix is added to distinguish the variant).

-- /example/ ASN1START
PRACH-ConfigSIB ::= SEQUENCE {
rootSequenceIndex INTEGER (0..1023),
prach-ConfigInfo
}
PRACH-Config ::= SEQUENCE {
rootSequenceIndex INTEGER (0..1023),
prach-ConfigInfo OPTIONAL -- Need N
}
PRACH-ConfigInfo ::= SEQUENCE {
prach-ConfigIndex ENUMERATED {ffs},
highSpeedFlag ENUMERATED {ffs},
zeroCorrelationZoneConfig ENUMERATED {ffs}
}
-- ASN1STOP

The configuration of measurements and reportings, both layer 1, L1, and layer 3, L3, measurements and reportings, to be performed by a UE are configured by RRC. There are a number of information elements, IEs, involved in this process. For example, the IE CSI-MeasConfig is used to configure:
Channel-State Information Reference Signals, CSI-RSs, belonging to the serving cell in which the CSI-MeasConfig is included
channel state information reports to be transmitted on the Physical Uplink Control Channel, PUCCH, on the serving cell in which the CSI-MeasConfig is included, and
channel state information reports on the Physical Uplink Shared Channel, PUSCH, triggered by Downlink Control Information, DCI, received on the serving cell in which the CSI-MeasConfig is included (see reference [1]).

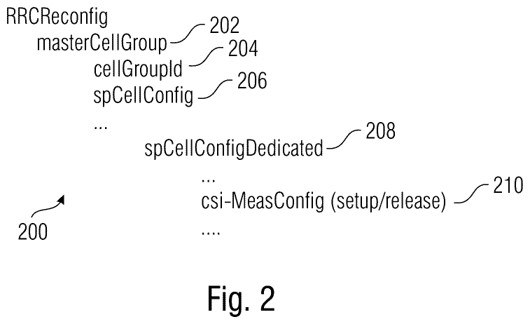

The CSI-MeasConfig is a part of the IE ServingCellConfig, which is used to configure (add or modify) the UE with a serving cell, which may be the Special Cell, SpCell, or a Secondary Cell, SCell, of a Master Cell Group, MCG, or a Secondary Cell Group, SCG. The parameters herein are mostly UE specific but partly also cell specific (e.g. in additionally configured bandwidth parts). The CSI-MeasConfig is used for beam mobility and channel state information. During RRCSetup and RRCReconfiguration, the field spCellConfigDedicated (of type ServingCellConfig) as a part of the CellGroupConfig is used to configure the CSI-MeasConfig. Note that field names start with lower case and types start with upper case letters. FIG. 2 illustrates the RRCReconfig message 200 including the fields masterCellGroup 202, cellGroupId 204, spCellConfig 206, and as part of the spCellConfigDedicated 208 the csi-MeasConfig (setup/release) 210.

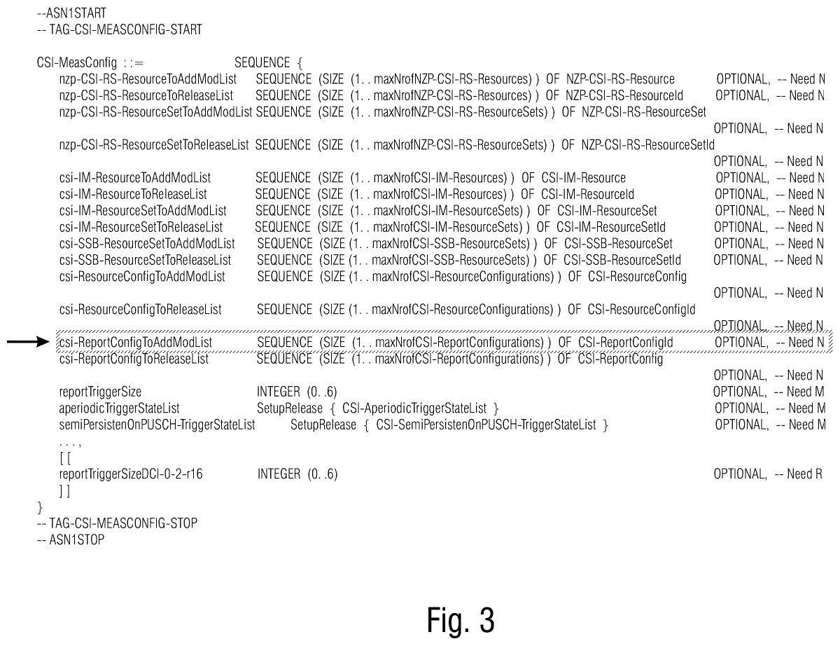

FIG. 3 illustrates the CSI-MeasConfig information element used to configure the CSI-RSs belonging to the serving cell in which CSI-MeasConfig is included, the channel state information reports to be transmitted on the PUCCH on the serving cell in which CSI-MeasConfig is included and the channel state information reports on the PUSCH triggered by DCI received on the serving cell in which CSI-MeasConfig is included (see section 6.3.2 of reference [1]).

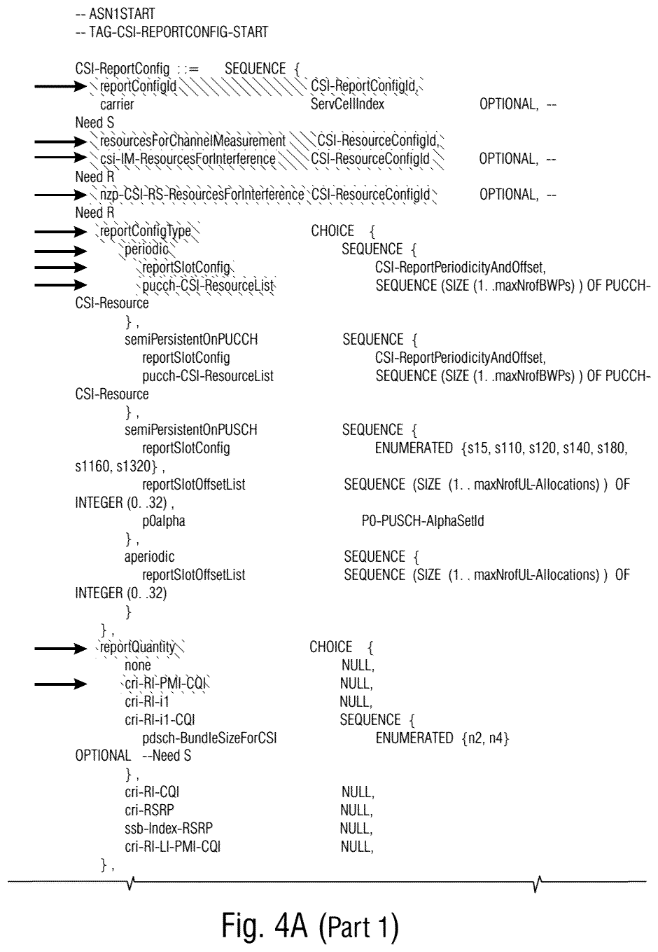

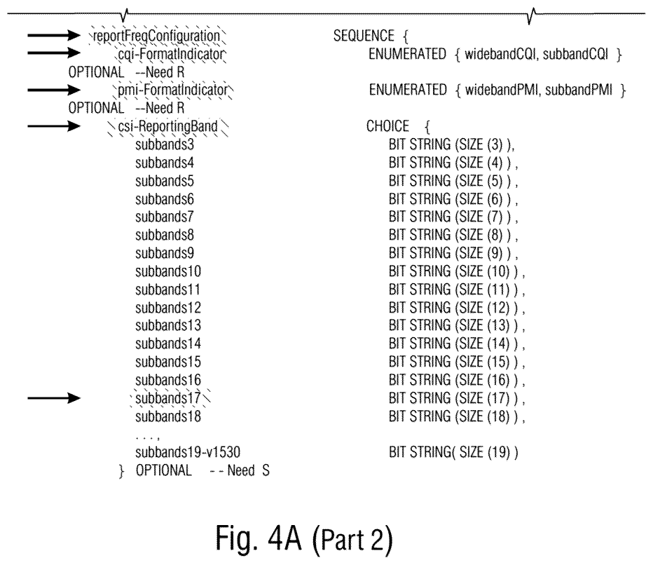

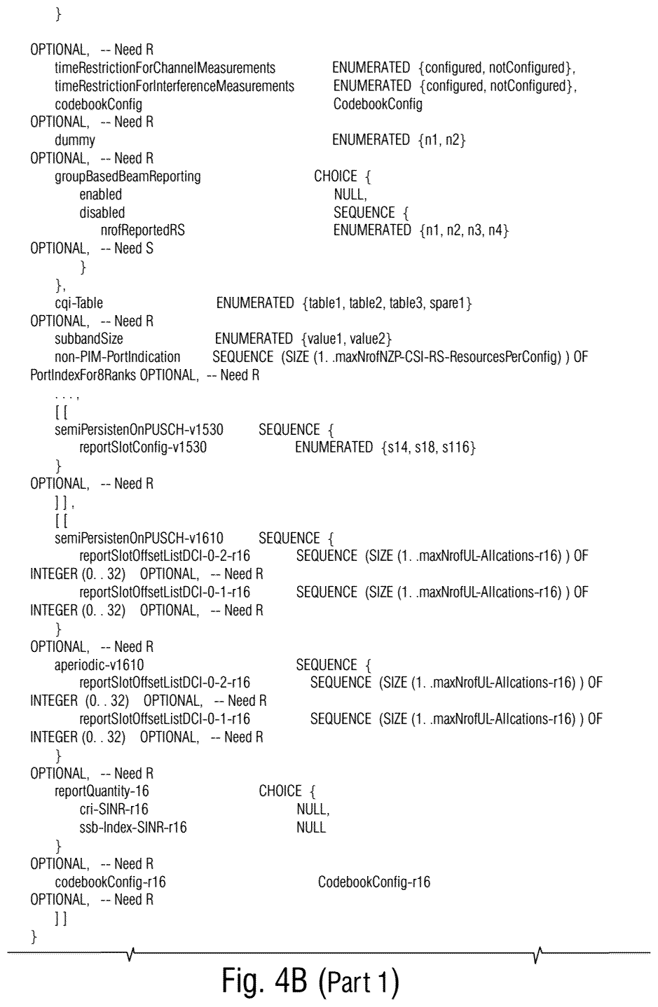

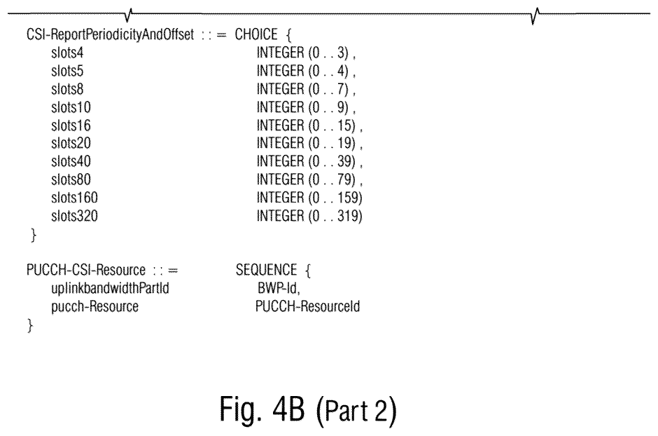

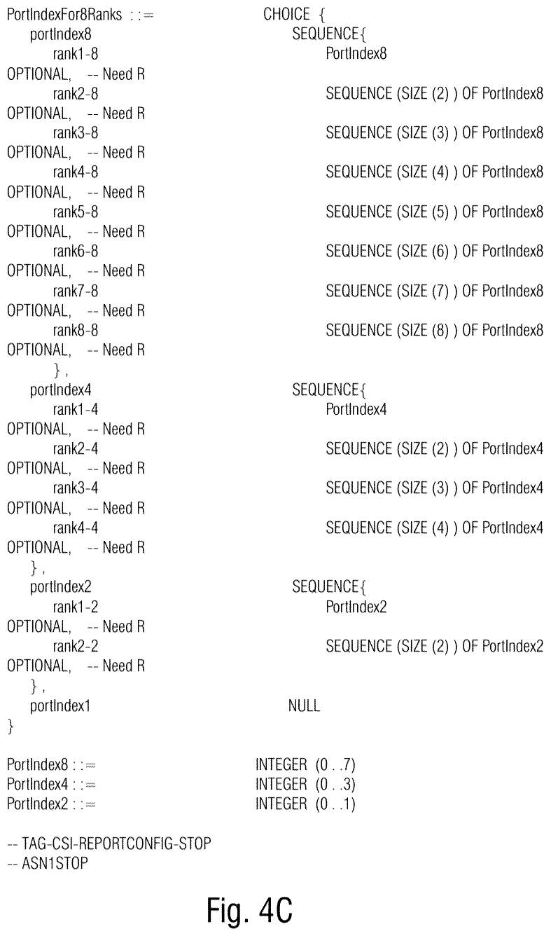

FIG. 4(A) to FIG. 4(C) illustrate the CSI-ReportConfig information element used to configure a periodic or semi-persistent report sent on the PUCCH on the cell in which the CSI-ReportConfig is included, or to configure a semi-persistent or aperiodic report sent on the PUSCH triggered by DCI received on the cell in which the CSI-ReportConfig is included (see section 6.3.2 of reference [1]). The top-level fields in CSI-ReportConfig 1E are highlighted in grey.

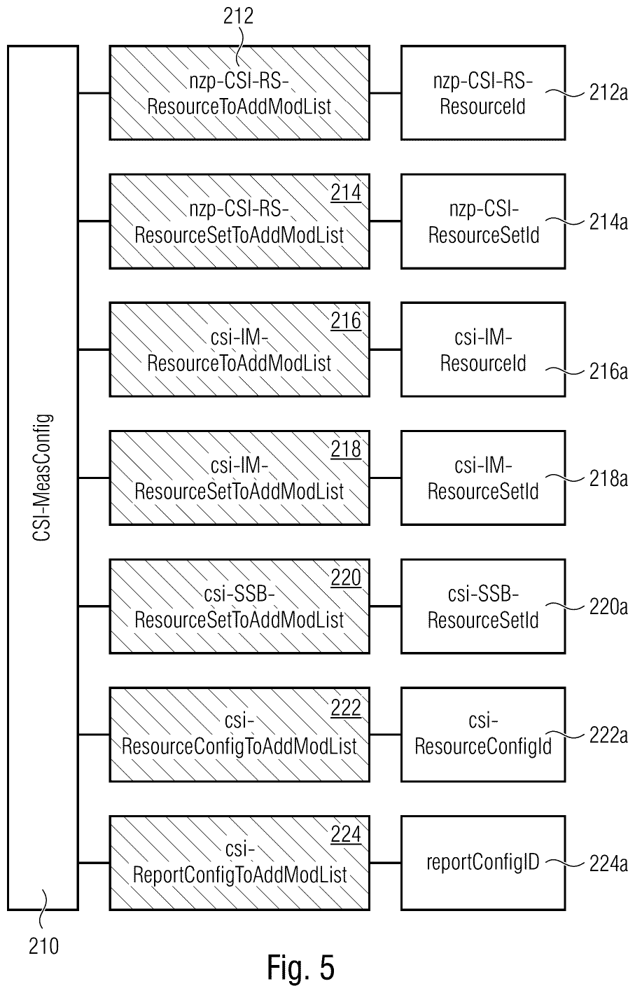

The CSI-MeasConfig contains the configuration for the CSI-RS resources, the CSI-Synchronization Signal Block, CSI-SSB, resources and the CSI interference management resources, as well as the report configuration. The resources and reporting configurations are configured through the use of the add-mod and release lists, as depicted in FIG. 5. FIG. 5 illustrates the setting up of CSI resources and reporting configuration via AddModList in a CSI-MeasConfig 210 which includes the following add-mod lists:
the nzp-CSI-RS-ResourceToAddModList 212 being a pool of NZP-CSI-RS-Resources which may be referred to from the NZP-CSI-RS-ResourceSet (NZP=Non Zero Power), and identified by the IE nzp-CSI-RS-Resourceld 212a,
nzp-CSI-RS-ResourceSetToAddModList 214 being a pool of NZP-CSI-RS-ResourceSets which may be referred to from the CSI-ResourceConfig or from MAC Control Elements, MAC CEs, and identified by the IE nzp-CSI-RS-ResourceSetId 214a,
csi-IM-Resource ToAddModList 216 being a pool of CSI-Interference Measurement Resources, CSI-IM-Resources, which may be referred to from the CSI-IM-ResourceSet, and identified by the csi-IM-Resourceld 216a,
csi-IM-ResourceSetToAddModList 218 being a pool of CSI-IM-ResourceSets, which may be referred to from the CSI-ResourceConfig or from MAC CEs, and identified by the csi-IM-ResourceSetId 218a,
csi-SSB-ResourceSetToAddModList 220 being a pool of CSI-SSB-ResourceSets which may be referred to from the CSI-ResourceConfig, and identified by the csi-SSB-ResourceSetId 220a,
csi-ResourceConfigToAddModList 222 indicating the configured CSI resource settings, and identified by the csi-ResourceConfigId 222a, and
csi-ReportConfigToAddModList 224 indicating the configured CSI report settings, and identified by the ReportConfigId 224a.

The above mentioned add/mod-lists and release-lists are used to benefit from delta signaling when modifying lists with many and/or large elements. Instead of a single list containing all elements of the list, the ASN.1 provides two lists. One list is used to convey the actual elements that are to be added to the list or modified in the list. The second list conveys only the identities (IDs) of the list elements that are to be released from the list. In other words, the ASN.1 defines only means to signal modifications to a list maintained in the receiver (typically the UE).

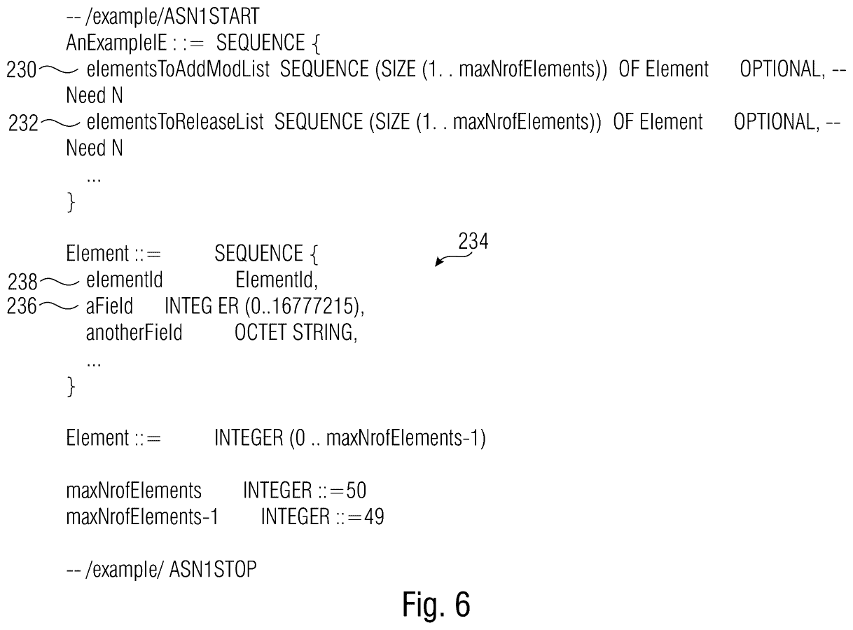

FIG. 6 is an example of an ASN.1 that provides the two lists, the elements ToAddModList 230 and the elements ToReleaseList 232, each including a reference to respective elements 234. As is illustrated, an element 234 of a list 230, 232 may contain an identity 236 (INTEGER) that identifies the element 234 unambiguously upon addition, modification and removal. Further, an IE for that identifier (ElementId 238) is defined so that it may be used both for a field inside the element as well as in the elementsToAddModList 230 and the elementsToReleaseList 232. Both lists 230, 232 may be made OPTIONAL and flagged as “Need N”. The need code reflects that the UE does not maintain the received lists 230, 232 as such but rather updates its configuration using the information therein. In other words, it is not possible to provide via delta signaling an update to a previously signaled elementsToAddModList 230 or elementsToReleaseList 232. The update is always in relation to the UE's internal configuration (see Annex A. 3.9 of reference [1]).

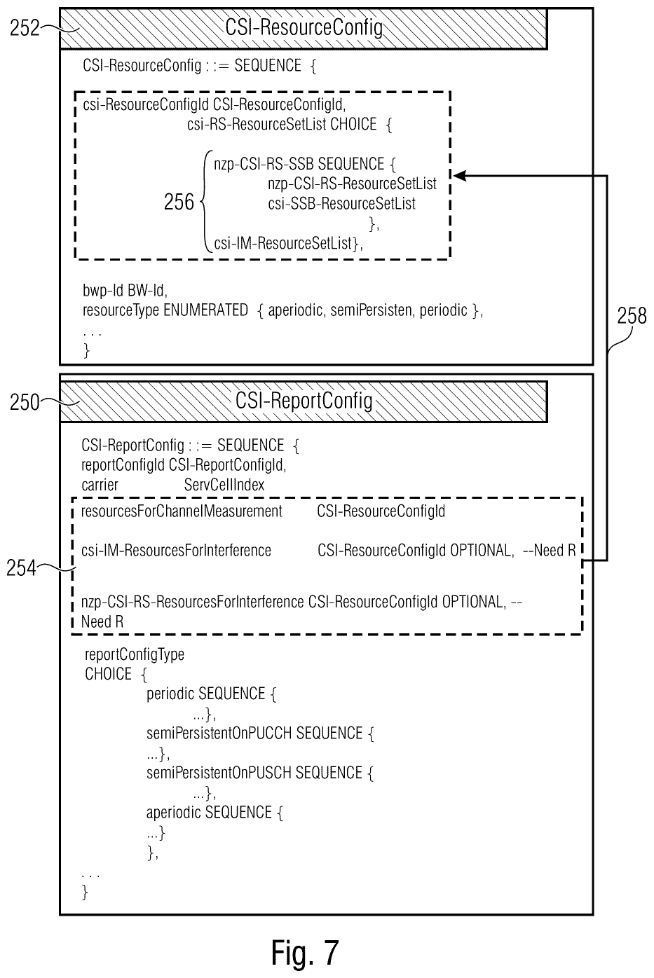

For a CSI-ReportConfig IE (see FIG. 4(A) to FIG. 4(C)), each report configuration, through its ID, uniquely identifies a report (see field “reportConfigId” in FIG. 4(A)). Such a report contains a number of fields (IEs), which may be local, i.e., inherent to the report configuration or may refer to other IEs, i.e., they are ‘foreign’. For example, FIG. 7 illustrates a link between CSI resources fields in a CSI-ReportConfig 250 and a CSI-ResourceConfig 252. The IE CSI-ReportConfig 250 is used to configure a periodic or semi-persistent report sent on the PUCCH on the cell in which the CSI-ReportConfig 250 is included, or to configure a semi-persistent or aperiodic report sent on the PUSCH triggered by DCI received on the cell in which the CSI-ReportConfig is included. The IE CSI-ReportConfig 250 includes a set 254 of resources for the measurements including the resources for a channel measurement, the csi-IM-Resources and the nzp-CSI-RS-Resources for an interference measurement, all identified by the CSI-ResourceConfigId from the CSI-ResourceConfig 252 as is indicated at 258. The CSI-ResourceConfig 252 defines a group 256 of one or more NZP-CSI-RS-ResourceSets, CSI-IM-ResourceSets and/or CSI-SSB-ResourceSets. In other words, the report 250 refers to specific resources for a channel measurement and an interference measurement, by referring to the CSI-ResourceConfig 1E 252 using appropriate IDs. A change of the resources on which the measurements and reporting are to be performed may be done using an add-mod list, i.e., via RRCReconfiguration. Hence, to change a report configuration 250, an RRCReconfiguration message is used, using the add-mod list.

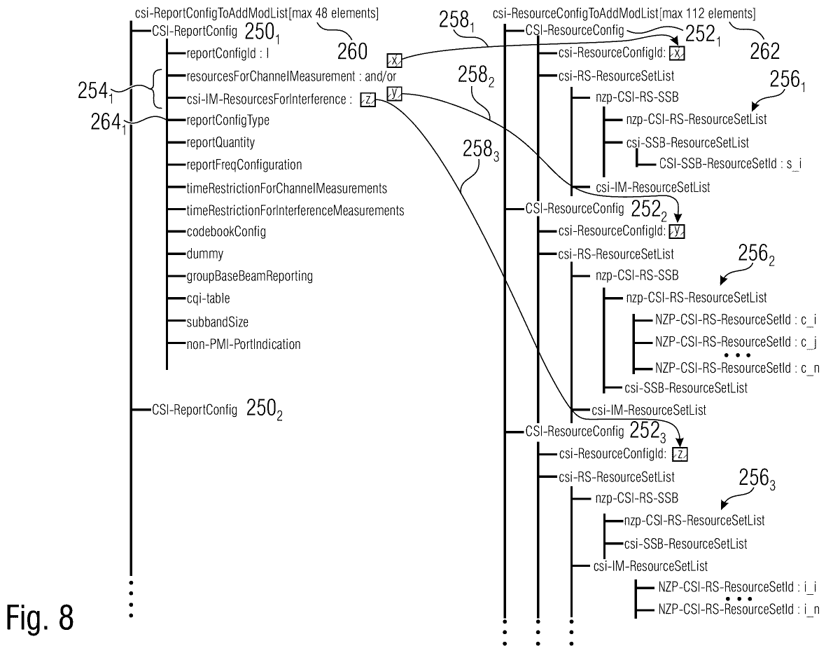

FIG. 8 illustrates the CSI reporting configuration and reporting (periodic and aperiodic) as described in reference [3], more specifically the RRC signaling between the UE and the network, NW, that configures the CSI reporting configuration for periodic and aperiodic reporting, and the lower-layer signaling that provides CSI report in the case of periodic and aperiodic reporting.

In the CSI-ReportConfig 250, there are two types of fields. They include the ones that belong to the CSI-ReportConfig 250 and the so-called ‘foreign’ IEs. The report configuration 250 specifies resources 254 for the channel measurement, the CSI-IM interference measurement resources and the nzp-CSI-RS for interference measurement. For example, the field resourcesForChannelMeasurement refers to the csi-ResourceConfigId, which is of the IE CSI-ResourceConfig 252. The IE 252 is included in the configuration of the serving cell indicated with the field “carrier” (see field “carrier” in FIG. 4(A)). The CSI-ResourceConfig indicated here contains only NZP-CSI-RS resources and/or SSB resources. For interference measurement, the CSI-ResourceConfig indicated here contains only CSI-IM resources. Also, nzp-CSI-RS-ResourcesForInterference refer to csi-ResourceConfigId of the CSI-ResourceConfig 252 included in the configuration of the serving cell indicated with the field “carrier”. The CSI-ResourceConfig indicated here contains only NZP-CSI-RS resources. The IE CSI-MeasConfig (see FIG. 3) is used to configure (i) CSI-RS belonging to the serving cell in which the CSI-MeasConfig is included, (ii) channel state information reports to be transmitted on the PUCCH on the serving cell in which CSI-MeasConfig is included and (iii) channel state information reports on the PUSCH triggered by DCI received on the serving cell in which CSI-MeasConfig is included.

Hence, the resources in the CSI report configuration 250 are linked 258 to the CSI resources configuration 252 as depicted in FIG. 7. The report configuration 250 specifies resources for the channel measurement and for the CSI-IM interference measurement resources and nzp-CSI-RS for the interference measurement. They may be a part of the same or different CSI-ResourceConfig IEs, which refers to resource set lists/resource lists and CSI-RS resources.

According to section 5.2.1.1 of reference [4], each reporting setting CSI-ReportConfig IE 250 may be associated with a single downlink bandwidth part, BWP, (.g., indicated by the higher layer parameter BWP-Id) given in the associated CSI-ResourceConfig 252 for the channel measurement and may contain the one or more parameters for one CSI reporting band: e.g., a codebook configuration including a codebook subset restriction, a time-domain behavior, a frequency granularity for the Channel Quality Indicator, CQI, and the Precoding Matrix Indicator, PMI, measurement restriction configurations, and CSI-related quantities to be reported by the UE such as the layer indicator, LI, L1-Reference Signal Receive Power, L1-RSRP, L1-Signal-to-Interference-and-Noise Ratio, L1-SINR, CSI-RS Resource Indicator, CRI, and SSB Resource Indicator, SSBRI.

The time domain behavior of the CSI-ReportConfig may be indicated by the reportConfigType and may be set to ‘aperiodic’, ‘semiPersistentOnPUCCH’, ‘semiPersistentOnPUSCH’, or ‘periodic’. For ‘periodic’ and ‘semiPersistentOnPUCCH’/′semiPersistentOnPUSCH′ CSI reporting, the configured periodicity and slot offset applies in the numerology of the UL BWP in which the CSI report is configured to be transmitted on. The RRC parameter reportQuantity indicates the CSI-related, L1-RSRP-related or L1-SINR-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSIReportConfig may be configured to enable time domain restriction for channel measurements and timeRestrictionForInterferenceMeasurements may be configured to enable time domain restriction for interference measurements. The CSI-ReportConfig may also contain the CodebookConfig, which contains configuration parameters for Type-I, Type II or Enhanced Type II CSI including codebook subset restriction, and configurations of group-based reporting.

As described above and as further illustrated in FIG. 8, a list 260 of report configurations includes a plurality of CSI-ReportConfigs 250₁, 250₂, . . . . CSI-ReportConfigs 250₁ includes the fields 254₁ (resourcesForChannelMeasurement, csi-IM-ResourcesForInterference, nzp-CSI-RS-ResourcesForInterference) that may refer to different resource configurations from a list 262 that includes a plurality of CSI-ResourceConfig IEs 252₁, 252₂, 252₃, . . . . The resources are identified through the IDs 258₁, 258₂, 258₃ for selecting the resources from the respective lists 256₁, 256₂, 256₃. Moreover, each CSI-ReportConfig supports a specific reporting type 264₁.

In order to change a given reporting configuration, respective IDs (indicated in FIG. 8 by X, Y and Z) need to be modified or added, using an RRC re-configuration message. The reporting configuration hence may refer to different RRC-configured CSI resources, which belong to different CSI-RS. One configuration report or more is defined per a measurement object. Hence, the same report configuration may not refer to a modified resource. Also, the other configuration parameters may not be changed for the same report configuration.

In case of aperiodic and semi-periodic reporting, the reporting is triggered using MAC/DCI signaling. More specifically, a UE may be configured by the network with a list of aperiodic trigger states for an aperiodic CSI reporting. A trigger state points to reference signals to be used for channel and interference measurements which may be combination of CSI-RS, SSB, and CSI-IM as well as a configuration on which CSI to report. DCI is used to indicate to the UE an aperiodic trigger state to be used for reporting CSI from the set of the configured trigger states. The maximum number of configured trigger states is 128 while DCI may only indicate one out of 63 states. Hence, when more than 63 states are configured, MAC CE is used to select which of the configured trigger states are mapped to the DCI codepoints. (see for example reference [2]).

Besides the above-described way of controlling the network using the RRC protocol, two other lower layer control or signaling mechanisms may be used to configure the PHY layer. These mechanisms include the MAC control elements, CEs, and the downlink control information, DCI. The MAC CEs may be used for activating/deactivating a particular reference signal or for activating/deactivating semi-persistent reporting on PUCCH, for example of channel state information as described in section 5.18 of Reference [5]. DCI, on the other hand, activates PUSCH-based semi-persistent CSI reporting. Besides, DCI provides the UE with the information entailed such as the physical layer resource allocation, which includes a number of parameters. For example, the modulation and coding scheme, MCS, the time and frequency resource assignment, precoding information and a number of ports on the uplink, UL, a SCI request, an indication of the transmission control states, TCI, and the like may be included. Additionally, DCI may support dynamic changes to the slot format, a dynamic power control, an identification of an availability of soft resources and the like, as described, for example, in section 7.3 of Reference [6]. The DCI is organized into different formats, and different identifiers are used to descramble DCI messages. For example, different formats are used for the scheduling information on the uplink and on the downlink, or for a compact DCI that provides a smaller amount of control information, or for indicating whether the DCI is used for power control or the like.

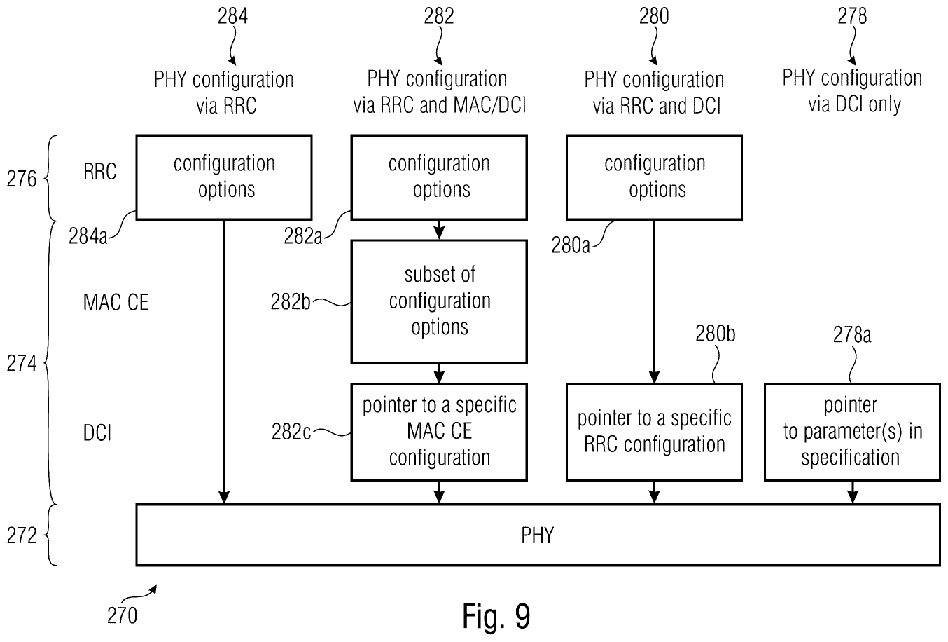

FIG. 9 summarizes the above-described possibilities for configuring, for example, the physical layer using RRC, MAC CE and DCI. FIG. 9, schematically, illustrates a part of the protocol stack 270 including layer 1, L1, 272, also referred to as the physical, PHY, layer, layer 2, L2, 274, also referred to as the MAC, RRC, PDCP layer, and layer 3, L3, 276, also referred to as the RRC layer. FIG. 9 illustrates an overview of the configuration mechanisms using RRC, MAC CE and DCI.

The physical layer 272 may be configured using DCI only, as is indicated at 278 by providing, using a DCI, a pointer, to one or more parameters in the specification, i.e., in the standard specification, as is indicated at 278a (when referring in this description to a “specification”, e.g., one or more of the 3GPP specifications may be meant). Also, a combination of RRC and DCI may be used, as is indicated at 280. For example, several RRC configurations may be provided for the UE, e.g., via RRC signaling, as is indicated at 280a. A desired configuration may be activated/deactivated, e.g., a SPS configuration, by providing in a DCI a pointer to the specific RRC configuration, as is indicated at 280b. Another example is a configuration of the physical layer using RRC and MAC/DCI, as is indicated at 282. Again, the configuration options are defined via RRC signaling, as is indicated at 282a, and a certain subset of configuration options may be selected via the MAC CE, like the above trigger states, as is indicated at 282b. Among these specific MAC CE configurations, by means of a DCI a specific one may be selected by sending a pointer using, for example a DCI as indicated at 282c. Another possibility for configuring the physical layer is to perform the configuration via RRC only as is indicated at 284. The physical layer operates in accordance with the configuration options in the RRC configuration as indicated at 284a.

The configuration structure as described with reference to FIG. 9 provides a great level of flexibility. For example, DCI 278 provides for a fast control of the configuration, however, it is constrained by the amount of information that may be carried. RRC 284, on the other hand, enables a great level of configuration flexibility, but it entails RRC reconfiguration signaling to the UE and is the slowest process of those described with reference to FIG. 9. The processes 280 and 282 allow narrowing down the options from all possible RRC configurations.

However, each of the configuration possibilities described within FIG. 9 and making use of the RRC configurations, namely options 280-284, fully rely on a UE that is configured or preconfigured with one or more RRC configurations including the respective fields for allowing the UE to perform a certain function or operation, and when being configured or preconfigured with the one or more UE configurations, the UE receives for the respective IEs or parameters defined in the UE configuration respective parameter values. In the description above, the IEs used, for example, for a measurement/report configuration were described in detail, however, the actual configuration at the UE is not in the form as described above with reference to FIG. 3 and FIG. 4(A) to FIG. 4(C), for example, rather for each of the fields or information elements, respective field values are indicated which are selected from those values available in accordance with the 3GPP specification.

For example, the RRC message including csi-ReportConfigToAddModList (highlighted in FIG. 3) indicates the configured CSI report settings, CSI-ReportConfig, which may include the following parameters or IEs highlighted in FIG. 4(A)

```
- reportConfigId
- resourcesForChannelMeasurement
- nzp-CSI-RS-ResourcesForInterference
- csi-IM-resourcesForInterference
- reportConfigType
  ∘ reportSlotConfig
  ∘ pucch-CSI-ResourceList
    ▪ uplinkBandwidthPartId
    ▪ pucchResource
- reportQuantity
- reportFreqConfiguration
  ∘ cqi-FormatIndicator
  ∘ pmi-FormatIndicator
  ∘ csi-ReportingBand
```

but specifies the actual parameter or field values so that what the UE actually decodes may look like

| | |
|---|---|
| reportConfigId | 0 |
| resourcesForChannelMeasurement: | 0 |
| csi-IM-resourcesForInterference | 10 |
| nzp-CSI-RS-ResourcesForInterference | 4 |
| reportConfigType: | |
| periodic | |
| reportSlotConfig: | −slots160:95 |
| pucch-CSI-ResourceList | [0] |
| uplinkBandwidthPartId: | 2 |
| pucchResource: | 12 |
| reportQuantity: | |
| cri-RI-PMI-CQI | null |
| reportFreqConfiguration | |
| cqi-FormatIndicator: | 0 |
| pmi-FormatIndicator: | 0 |
| csi-ReportingBand: | |
| subbands17 | 262143 |

Thus, what is actually received at the UE in the form of the RRC configuration is that a certain parameter or field has associated one or more field values with it, and dependent on the configuration mechanism (see FIG. 9), either a value directly from the RRC configuration is used or, in case the configuration includes for a certain field a plurality of values, via MAC CE/DCI, one of the field values may be selected by including a pointer to the desired value in the MAC CE/DCI signaling.

However, the actual UE configuration or RRC configuration present at the UE remains unchanged, and for parameters for which only single values are available no selection via the MAC CE/DCI mechanism is possible. Thus, while the RRC approach provides a huge number of configuration parameters using the respective information elements, IEs, only for some of the configuration parameters or fields options may be selected through the more dynamic MAC CE/DCI signaling—with the options, however, being already fixedly defined via the RRC configuration or preconfigured in the UE as per specification, like the 3GPP specification. In other words, only for some of the parameters the MAC CE/DCI signaling options exist so as to allow selecting from several parameter values associated with a certain IE a desired one. However, it is to be stressed again that, also in such cases, the RRC configuration itself remains the same, i.e. it is not changed.

Thus, the entire UE configuration is actually prone to signaling overhead and processing delays in that almost any change of the basic configuration options uses an RRC reconfiguration. However, when considering, for example, multi transmission/reception point, multi-TRP, transmission/reception scenarios or multi-antenna devices across the wireless communication network or radio network that may, in itself, be heterogeneous, there is a need for a more dynamic and lightweight signaling of a configuration, like a transmission/reception configuration or a configuration of measurement and reporting. Moreover, a lightweight signaling may become even more important in case different types of NR devices are used, for example so called RedCap devices having a reduced complexity and power savings being of the main requirements of such devices. Reduced Capability, RedCap, user devices may be UEs having less capabilities when compared to other UEs, e.g., to enhanced Mobile BroadBand, eMBB, UEs. The capabilities concerned may include a maximum bandwidth such a UE may support. For example, when operating in Frequency Range 1, FR1, the UE may support a maximum of 20 MHz bandwidth, and when operating in Frequency Range 2, FR2, the UE may support up to 100 MHz bandwidth. Further requirements of a RedCap UE may include one or more of the following:
Device complexity: reduced costs and complexity when compared to high-end eMBB and Ultra Reliable Low Latency Communication, URLLC, devices.
Device size: for most use cases device design with compact form factor is decried.
Deployment scenarios: support of all FR1/FR2 bands for Frequency Division Duplexing, FDD, and Time Division Duplexing, TDD.

RedCap UEs may comprise also industrial sensors or wearables using SL communication to communicate with other UEs directly. For example, wearables may use SL communication to communicate with cars or other wearables directly.

Thus, there is a substantial need to use lightweight signaling calls for expanding the framework of MAC CE/DCI configurations to a greater range of parameters in addition to using RRC signaling only.

For example, when considering feedback aspects, conventionally, wireless communication systems or networks make use of a closed loop feedback approach for a variety of purposes including, for example, link optimization, cell optimization and interference management. In many of such scenarios, there is a two node configuration in which the two nodes are connected by a bidirectional link including physical links, logical links and the like. For example, a common scheme for a closed loop link optimization may be the closed loop antenna port selection in 4G-LTE and 5G-NR. A base station, like a gNB, broadcasts reference signals, RSs, marking specific spatially beamformed radiation patterns transmitted by the gNB, and the markers are quasi collocated, QCLed, with the system synchronization block, SSB, which is broadcast in regular intervals. A UE may scan for SSBs to start a random access procedure on the strongest SSB signal observed. Once the access to the system is granted, the gNB may configure the UE to report on various parameters, for example Signal to Noise Ratio, SNR, Signal to Interference and Noise Ratio, SINR, Rank Indicator, RI, Channel Quality Indicator, CQI, and the like and grants appropriate uplink resources to send the feedback in an associated control channel. Conventionally, this is done by configuring the UE into a predefined, standardized mode with associated well-defined structure, syntax and the like of the message space and format, for example, by using the configuration messages and information elements described above with reference to FIG. 3 and FIG. 4(A) to FIG. 4(C). For example, in case of CQI and RI feedback, the UE is observing/measuring RSs mapped to specific antenna ports by the gNB, also referred to CSI-RS, which allow for a spatial estimation of the wireless propagation channel. The UE has, for example, two options for a feedback:
Type 1 feedback: the UE feeds backs a codebook entry representing the antenna port and an advantageous spatial precoder to be used by the gNB for future transmissions.
Type 2 feedback: the feeds back more than one codebook entry and associated phase and amplitude values instructing the gNB to co-phase the index beams in order to optimize the SINR of the resulting signal at the receiver.

The just-mentioned feedback works reliably within limits, having, however, rather limited flexibility. In particular, if a more advanced link selection and optimization scheme is to be implemented, the existing feedback schemes may not be suitable anymore as respective changes in the feedback format and the associated bit stream space may be entailed. Conventional approaches do not allow for configuring a UE going beyond what is currently defined in the standards.

The present invention addresses the above-summarized issues by providing enhancements and improvements for configuring a user device in a wireless communication network with an increased flexibility.

### First Aspect—Modifying/Combining Existing Configurations

In accordance with a first aspect of the present invention, one or more configurations with which a UE is configured or preconfigured may be modified without the need for sending a new, complete RRC configuration.

More specifically, in accordance with a first embodiment of the first aspect of the present invention, a UE may be configured with an existing configuration having fields with associated field values, and one or more of such field values may be modified by replacing the original field values by new field values that may be received in a control message or that may be selected by the UE dependent on certain criteria independent from any other signaling. The new field values need to be permitted values-they may be within a range already defined during a previous RRC configuration or defined in the specification or the like.

In accordance with a second embodiment of the first aspect of the present invention, a UE that is configured with a plurality of UE configurations may be triggered to combine or more parameters from the respective configurations into a new configuration so as to operate in accordance with a desired function to be performed by the UE. The UE may decide about combining configurations or parameters from different configurations into a new configuration responsive to a signaling from another network entity or on its own dependent on certain criteria.

The first aspect of the present invention is advantageous as it enhances the flexibility of the UE configurations with which a UE may be configured or preconfigured in that the UE, either on its own or responsive to a signaling, like a MAC CE/DCI signaling may modify existing field values for certain fields within the existing UE configuration, i.e., there is no need for a complete reconfiguration of the UE by sending a complete new configuration, rather, the field values may be modified or changed to a new value dependent on certain requirements or criteria the UE determines on its own or responsive to a signaling from a different network entity, like the gNB or a sidelink UE. For example, the signaling may be performed using a signaling in a layer of the protocol stack that is lower than the layer used for sending the UE configuration. For example when considering a 3GPP wireless communication system, the RRC configuration is signaled in the RRC layer, however, in accordance with embodiments of the present invention, the modification of the field values or the indication of what elements from the respective existing configurations are to be combined may be signaled in the L1/L2 layer using the above-described MAC CE/DCI signaling. In accordance with other embodiments, the signaling may also be in the RRC layer, however, for such a signaling only a short message is needed which is more efficient in terms of transmission speed and the like when compared to transmitting a complete new UE configuration with, for example, only one or two field values changed when compared to the existing UE configuration.

### Second Aspect—Populating/Combining Configuration Templates

In accordance with a second aspect of the present invention, rather than providing a complete UE configuration on the basis of which a UE may operate, one or more so-called templates or configuration templates are provided. The templates may include, in a similar way as existing configurations, certain fields or parameters for defining certain field values or parameter values to be used or employed by the UE when performing a certain function or operation. Initially, the configuration template does not include any actual or valid field values for one or more or all fields, but only placeholders. The placeholder may be represented by a certain character, letter or number not representing a valid value to be used by the UE. The placeholder or placeholder value may also be an arbitrary field value as it is available in accordance with the standardization or specification or for a certain IE, as for example, described in Reference [1] with regard to the measurement/reporting configurations described above with reference to FIG. 3 and FIG. 4(A) to FIG. 4(C). However, one or more or all of the field values may be indicated as not valid for use at the UE, i.e., are signaled as a kind of placeholder.

In accordance with a first embodiment of the second aspect of the present invention, the UE is configured or preconfigured with configuration templates and may generate an actual configuration for performing a certain operation or function by replacing in the template the one or more placeholders for a field or parameter by a certain field value. In a similar way as described above with reference to the first aspect, the actual value to be used for a placeholder may be determined by the UE itself or may be received by a signaling, for example by using a MAC CE/DCI signaling or by using a small RRC signaling message.

In accordance with a second embodiment of the second aspect of the present invention, the UE may include a plurality of configuration templates and, responsive to a signaling or on its own may generate a new configuration template from the existing configuration templates so as to achieve a desired function or operation.

For example, in accordance with the second aspect of the present invention, the syntax and message space may be defined by one side of the wireless link and mapped onto a standardized template as a basic element to convey format, message space and syntax of a newly defined feedback. Such a template based wireless system feedback scheme design allows organic and modular further development of a new feedback mechanism and the implementation in existing networks including legacy devices, in case they fulfill the specific requirements which are particular to a new feedback scheme, for example support certain measurements and metrics needed for the scheme. The advantage of the use of templates, like feedback templates, FBT, is that they open the way for fast innovation and implementation in live systems and in particular software based pre-evaluation of system gains and in-situ testing using templates so that advantages and gains about certain configurations may be evaluated significantly faster.

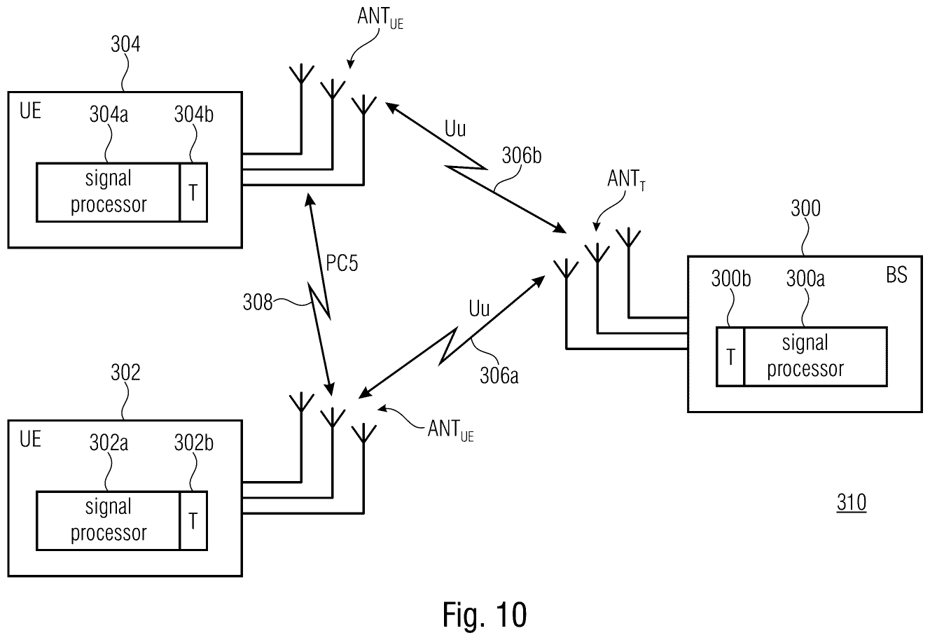

Embodiments of the present invention may be implemented in a wireless communication system as depicted in FIG. 1(A) and FIG. 1(B) including base stations and users, like mobile terminals or IoT devices or industrial IoT (IIoT) devices. FIG. 10 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 10, the one or more UEs 302, 304 of FIG. 10, and the base station 300 of FIG. 10 may operate in accordance with the inventive teachings described herein.

### First Aspect: Modify Existing Configurations—UE

### Change Field Values of a Higher Layer Configuration Via Lower Layer Control Message

The present invention provides a user device, UE, for a wireless communication system, like a 3^{rd} Generation Partnership Project, 3GPP, system, the UE comprising:
one or more antennas,
a signal processor connected to the antenna, and
one or more configurations,
wherein the configuration
   is associated with one or more certain operations to be performed by the signal processor,
   defines one or more fields concerning the certain operation, and
   includes for each field one or more field values to be applied or used by the UE when performing the certain operation,
wherein the UE is to operate in accordance with the configuration, and
wherein the UE is to generate a new configuration by modifying the configuration by replacing the field value for a field in the configuration by a new field value.

In accordance with embodiments, the UE is to modify the configuration for obtaining a new configuration
responsive to one or more control messages, the control message including for one or more or all of the fields of the configuration one or more new field values, or
responsive to one or more criteria, wherein the UE is to select for one or more or all of the fields of the configuration one or more new field values in accordance with the one or more criteria.
   Combine Higher Layer Configurations into New Configuration

The present invention provides a user device, UE, for a wireless communication system, like a 3^{rd} Generation Partnership Project, 3GPP, system, the UE comprising:
one or more antennas,
a signal processor connected to the antenna, and
a plurality of configurations,
wherein each configuration
   is associated with one or more certain operations to be performed by the signal processor,
   defines one or more fields concerning the certain operation, and
   includes for each field one or more field values to be applied or used by the UE when performing the certain operation,
wherein the UE is to generate a new configuration using two or more of the plurality of configurations.

In accordance with embodiments, the UE is to generate the new configuration
by combining one or more fields from the two or more configurations into the new configuration, and/or
using a description of a desired operation to be performed by the UE.

In accordance with embodiments, for generating the new configuration, the UE is to
add selected fields to one of the plurality of configurations to obtain the new configuration, or
copy one of the plurality of configurations and add the fields to the copied configuration, thereby generating the new configuration and maintaining the original configuration, or
combine selected fields into the new configuration, or
exchange/sort selected fields into the new configuration, or
fuse selected fields into a new field into the new configuration.

In accordance with embodiments, the UE is to generate the new configuration
responsive to one or more control messages, the control message including the one or more fields to be combined and/or the description of the desired operation, or
responsive to one or more criteria, wherein the UE is to select the one or more fields to be combined and/or the desired operation in accordance with the one or more criteria.

In accordance with embodiments, the one or more criteria comprise one or more of the following:
one or more events, like a handover, HO, or a conditional handover, CHO, of the UE from a source base station to a target base station,
a change of a beam or of one of a plurality of transmission/reception points, TRPs,
a reference signal of a serving cell or beam falls below a predefined threshold,
a reference signal of a neighboring cell or beam exceeds a predefined threshold,
an interference on a specified resource of a serving cell or beam exceeds a predefined threshold,
one or more certain events internal to the UE.

In accordance with embodiments,
the UE is configured with the one or more configurations via one or more configuration messages in a first layer of a protocol stack of the wireless communication system, like the RRC layer, and
wherein the UE is to receive the one or more control messages in one or more second layers of the protocol stack, like the PHY layer, the second layer being lower than the first layer.

In accordance with embodiments,
the UE is configured with the one or more configurations via one or more configuration messages in a first layer of a protocol stack of the wireless communication system, like the RRC layer, and
wherein the UE is to receive the one or more control messages in the first layer of the protocol stack, the control message being a further configuration message having a size smaller than a size of the configuration message.

In accordance with embodiments,
the UE is preconfigured with the one or more configurations, and
wherein the UE is to receive the one or more control messages in in a certain layer of a protocol stack of the wireless communication system, the certain layer of the protocol stack being
   a first layer of the protocol stack used for transmitting one or more configuration messages, like the RRC layer, the control message being a further configuration message having a size smaller than a size of a configuration message, or
   a second layer, like the PHY layer, being lower than the first layer.

In accordance with embodiments, the UE is to modify the configuration
responsive to the receipt of the control message, or
at predefined time, e.g., after lapse of a time period or at an explicit point of time, which may be signaled to the UE together with the control message, or
when one or more of predefined conditions are met, like
   one or more events occur, like a handover, HO, or a conditional handover, CHO, of the UE from a source base station to a target base station,
   a change of a beam or of one of a plurality of transmission/reception points, TRPs,
   a reference signal of a serving cell or beam falls below a predefined threshold,
   a reference signal of a neighboring cell or beam exceeds a predefined threshold,
   an interference on a specified resource of a serving cell or beam exceeds a predefined threshold,
   one or more certain events internal to the UE.

In accordance with embodiments, the UE is to report the new configuration to one or more network entities using, e.g., one or more report messages including a description of the new configuration indicating the fields modified in the configuration and the one or more new field values associated with the modified fields.

In accordance with embodiments, the UE is to operate in accordance with the new configuration.

In accordance with embodiments, the UE is to operate in accordance with the new configuration for a predefined time and/or until one or more of the following conditions are met:
an activation of a different configuration from the one or more configurations,
a certain event or trigger occurs, such as a cell, a beam or a TRP change, or a control information signal reception indicating a change in spatial and other QCL-relations in DL reference signals, causing a change in
   a cell-level, a beam level and a CSI measurement and reporting, specifying a change in reporting quantity, measurement granularity, measurement resources, power-levels associated with reporting, etc.,
   a DL or UL BWP, its subcarrier spacing and cyclic prefix configuration, the UE's configuration of MIMO layers, antenna and codebook configuration,
   a DRX configuration,
   any of the above or other appropriate parameters in any of the serving cells,
one or more certain other events or triggers, like a reference signal RSRP/RSRQ/SINR of a serving cell/beam falling below a predefined threshold and/or a neighbor cell/beam reference signal RSRP/RSRQ/SINR exceeding a predefined threshold, or an interference level on a specified resource of a serving cell/beam exceeding or falling below a predefined threshold, causing the UE to, e.g., change a cell-level, a beam level and a CSI measurement and reporting, specifying a change in reporting quantity, measurement granularity, measurement resources,
one or more events or triggers internal to the UE, causing the UE to modify, e.g., a DRX configuration, or a power level and frequency and granularity of cell or beam and CSI measurement and reporting, a scheduling requests configuration, a change in the UE's configuration of MIMO layers and antenna configuration, a change or deactivation of CA or DC cells, specific events or triggers such as
   a battery level falls below a predefined threshold,
   a memory or CPU usage reaches a predefined threshold,
   a buffer exceeds a predefined threshold,
   an overheating.

In accordance with embodiments, the UE is to maintain a current configuration as a default or old configuration, and is to operate according to the default or old configuration after the predefined time and/or once one or more of the conditions, which do not cause the UE to use a configuration different from the default or old configuration, are met.

In accordance with embodiments,
the predefined time is a certain duration or time period for which or after which the new configuration is to be employed by the UE, and
the UE comprises a timer set in accordance with the predefined time so that a lapse of the timer causes the UE to stop or start using the new configuration.

In accordance with embodiments, the UE is preconfigured with the predefined time or is configured with the predefined time via a signaling, e.g., the predefined time may be included in the control message.

In accordance with embodiments, the UE is to start operating in accordance with the new configuration after a predefined time expires and/or until one or more of the following conditions are met:
a deactivation of the currently used configuration,
a certain event, which was predefined as a condition e.g. when a battery threshold is passed,
a certain trigger, like a signal received or a trigger derived from one or more conditions met in a certain functional relationship e.g. XOR, AND, etc.,

### Second Aspect: Configuration Templates—UE

Populate Higher Layer Configuration Template with Field Values

The present invention provides a user device, UE, for a wireless communication system, like a 3^{rd} Generation Partnership Project, 3GPP, system, the UE comprising:
one or more antennas,
a signal processor connected to the antenna, and
one or more configuration templates,
wherein the configuration template
   is associated with one or more certain operations to be performed by the signal processor,
   defines one or more fields concerning the certain operation, and
   includes for one, some or all fields a placeholder for one or more field values,
wherein the UE is to generate a configuration for performing the certain operation by replacing in the configuration template the placeholder for a field by a field value.

In accordance with embodiments, the UE is to replace a placeholder for a field by a field value
responsive to one or more control messages, the control message including for one or more or all of the fields of the configuration template one or more field values, or
responsive to one or more criteria, wherein the UE is to select for one or more or all of the fields of the configuration template one or more field values in accordance with the one or more criteria.

In accordance with embodiments, for generating the configuration, the UE is to copy the configuration template and replace in the copied configuration template the placeholder for a field by a field value from the control message, thereby generating the configuration for performing the certain operation and maintaining the original configuration template.

In accordance with embodiments, the UE is to operate in accordance with the generated configuration.

In accordance with embodiments, the UE is to operate in accordance with the generated configuration for a predefined time and/or until one or more of the following conditions are met:
an activation of a different configuration from the one or more configurations,
a certain event or trigger occurs, such as a cell, a beam or a TRP change, or a control information signal reception indicating a change in spatial and other QCL-relations in DL reference signals, causing a change in
   a cell-level, a beam level and a CSI measurement and reporting, specifying a change in reporting quantity, measurement granularity, measurement resources, power-levels associated with reporting, etc.,
   a DL or UL BWP, its subcarrier spacing and cyclic prefix configuration,
   the UE's configuration of MIMO layers, antenna and codebook configuration,
   a DRX configuration,
   any of the above or other appropriate parameters in any of the serving cells,
one or more certain other events or triggers, like a reference signal RSRP/RSRQ/SINR of a serving cell/beam falling below a predefined threshold and/or a neighbor cell/beam reference signal RSRP/RSRQ/SINR exceeding a predefined threshold, or an interference level on a specified resource of a serving cell/beam exceeding or falling below a predefined threshold, causing the UE to, e.g., change a cell-level, a beam level and a CSI measurement and reporting, specifying a change in reporting quantity, measurement granularity, measurement resources,
one or more events or triggers internal to the UE, causing the UE to modify, e.g., a DRX configuration, or a power level and frequency and granularity of cell or beam and CSI measurement and reporting, a scheduling requests configuration, a change in the UE's configuration of MIMO layers and antenna configuration, a change or deactivation of CA or DC cells, specific events or triggers such as
   a battery level falls below a predefined threshold,
   a memory or CPU usage reaches a predefined threshold,
   a buffer exceeds a predefined threshold,
   an overheating.

In accordance with embodiments, the UE is to maintain a current configuration as a default or old configuration, and is to operate according to the default or old configuration after the predefined time and/or once one or more of the conditions, which do not cause the UE to use a configuration different from the default or old configuration, are met.

In accordance with embodiments,
the predefined time is a certain duration or time period for which or after which the new configuration is to be employed by the UE, and
the UE comprises a timer set in accordance with the predefined time so that a lapse of the timer causes the UE to stop or start using the new configuration.

In accordance with embodiments, the UE is preconfigured with the predefined time or is configured with the predefined time via a signaling, e.g., the predefined time may be included in the control message.

In accordance with embodiments, the UE is to start operating in accordance with the generated configuration after a predefined time expires and/or until one or more of the following conditions are met:
an activation of a different configuration from the one or more configurations,
a certain event or trigger occurs, such as a cell, a beam or a TRP change, or a control information signal reception indicating a change in spatial and other QCL-relations in DL reference signals, causing a change in
   a cell-level, a beam level and a CSI measurement and reporting, specifying a change in reporting quantity, measurement granularity, measurement resources, power-levels associated with reporting, etc.,
   a DL or UL BWP, its subcarrier spacing and cyclic prefix configuration,
   the UE's configuration of MIMO layers, antenna and codebook configuration,
   a DRX configuration,
   any of the above or other appropriate parameters in any of the serving cells,
one or more certain other events or triggers, like a reference signal RSRP/RSRQ/SINR of a serving cell/beam falling below a predefined threshold and/or a neighbor cell/beam reference signal RSRP/RSRQ/SINR exceeding a predefined threshold, or an interference level on a specified resource of a serving cell/beam exceeding or falling below a predefined threshold, causing the UE to, e.g., change a cell-level, a beam level and a CSI measurement and reporting, specifying a change in reporting quantity, measurement granularity, measurement resources,
one or more events or triggers internal to the UE, causing the UE to modify, e.g., a DRX configuration, or a power level and frequency and granularity of cell or beam and CSI measurement and reporting, a scheduling requests configuration, a change in the UE's configuration of MIMO layers and antenna configuration, a change or deactivation of CA or DC cells, specific events or triggers such as
   a battery level falls below a predefined threshold,
   a memory or CPU usage reaches a predefined threshold,
   a buffer exceeds a predefined threshold,
   an overheating.

In accordance with embodiments, the UE is to report the generated configuration to one or more network entities using, e.g., one or more report messages including a description of the generated configuration indicating the fields in the generated configuration and the one or more new field values associated with the fields.

Modify Configuration Generated from Configuration Template

In accordance with embodiments, the UE is to
modify the generated configuration by replacing the field value for a field in the generated configuration by a new field value, and
operate in accordance with the new configuration.

In accordance with embodiments, the UE is to modify the generated configuration for obtaining a new configuration
responsive to one or more further control messages, the further control message including for one or more or all of the fields of the generated configuration one or more new field values, or
responsive to one or more criteria, wherein the UE is to select for one or more or all of the fields of the generated configuration one or more new field values in accordance with the one or more criteria.
   Combine Higher Layer Configuration Templates into New Template

The present invention provides a user device, UE, for a wireless communication system, like a 3^{rd} Generation Partnership Project, 3GPP, system, the UE comprising:
one or more antennas,
a signal processor connected to the antenna, and
a plurality of configuration templates,
wherein each configuration template
   is associated with one or more certain operations to be performed by the signal processor,
   defines one or more fields concerning the certain operation, and
   includes for one, some or all fields a placeholder for one or more field values,
wherein the UE is to generate a new configuration template using two or more of the plurality of configuration templates.

In accordance with embodiments, the UE is to generate the new configuration template
by combining one or more fields from the two or more configuration templates into the new configuration template, and/or
using a description of a desired operation to be performed by the UE.

In accordance with embodiments, for generating the new configuration template, the UE is to
add selected fields to one of the plurality of configuration templates to obtain the new configuration template, or
copy one of the plurality of configuration templates and add selected fields to the copied configuration template, thereby generating the new configuration template and maintaining the original configuration template, or
combine selected fields into the new configuration template, or
combine selected IEs into the new configuration template.

In accordance with embodiments, the UE is to generate the new configuration template
responsive to one or more control messages, the control message including the one or more fields to be combined and/or the description of the desired operation, or
responsive to one or more criteria, wherein the UE is to select the one or more fields to be combined and/or the desired operation in accordance with the one or more criteria.

In accordance with embodiments, the UE is to report the new configuration template to one or more network entities using, e.g., one or more report messages including a description of the new configuration template indicating the fields in the new configuration template.

In accordance with embodiments, the UE is to
generate a configuration for performing the certain operation by replacing in the new configuration template the placeholder for a field by a field value, and
operate in accordance with the generated configuration.

In accordance with embodiments, the UE is to replace a placeholder for a field by a field value
responsive to one or more further control messages, the further control message including for one or more or all of the fields of the new configuration template one or more field values, or
responsive to one or more criteria, wherein the UE is to select for one or more or all of the fields of the new configuration template one or more field values in accordance with the one or more criteria.

In accordance with embodiments, for generating the configuration, the UE is to copy the new configuration template and replace in the copied new configuration template the placeholder for a field by a field value from the control message, thereby generating the configuration for performing the certain operation and maintaining the original new configuration template.

In accordance with embodiments,
the UE is configured with the one or more configuration templates via one or more configuration messages in a first layer of a protocol stack of the wireless communication system, like the RRC layer, and
wherein the UE is to receive the one or more control messages in one or more second layers of the protocol stack, like the PHY layer, the second layer being lower than the first layer.

In accordance with embodiments,
the UE is configured with the one or more configuration templates via one or more configuration messages in a first layer of a protocol stack of the wireless communication system, like the RRC layer, and
wherein the UE is to receive the one or more control messages in the first layer of the protocol stack, the control message being a further configuration message having a size smaller than a size of the configuration message.

In accordance with embodiments,
the UE is preconfigured with the one or more configuration templates, and
wherein the UE is to receive the one or more control messages in in a certain layer of a protocol stack of the wireless communication system, the certain layer of the protocol stack being
   a first layer of the protocol stack used for transmitting one or more configuration messages, like the RRC layer, the control message being a further configuration message having a size smaller than a size of a configuration message, or
   a second layer, like the PHY layer, being lower than the first layer.

### General Definitions Applying to all Previous UEs

In accordance with embodiments,
the UE is to receive from one or more entities of the wireless communication system, like a base station or another UE, an activation signal or activation condition of the new configuration/new configuration template, and
the UE is to make use of the new configuration/new configuration template only responsive to the activation signaling or activation condition.

In accordance with embodiments,
the UE is to receive the one or more control messages/further control signals from one or more entities of the wireless communication system, like a base station or another UE, and
the UE is to signal a completion of creating a configuration/new configuration template, e.g., to the entity of the wireless communication system that provided the control message.

In accordance with embodiments, the field value for a field in a configuration includes one or more of:
a certain value for a parameter specified by the field,
a resolution of a value in terms of a certain unit value, e.g. xx digits before and/or after comma
a reference to another configuration for the UE,
a procedural command describing an operation on values described in fields,
a concatenation order of commands.

In accordance with embodiments, the certain operation incudes one or more of the following:
a communication, like a transmission and/or a reception of data, with to one or more entities of the wireless communication system,
a measurement of the radio environment and reporting of the measurements to one or more entities of the wireless communication system,
configuration/change of PHY and/or higher layer for transmissions and/or reception
a feedback to be provided by the UE to one or more entities of the wireless communication system.

In accordance with embodiments,
for the transmission and/or a reception of data, the UE is configured by one or more of the following configurations or configuration templates:
   a serving beam/cell configuration or configuration template, including beam failure recovery, Secondary Cell, SCell, and Primary SCell, PSCell, configurations or configuration templates,
   a configuration or configuration template for a bandwidth part of any serving cell,
   a configuration or configuration template for a slot format,
   a configuration or configuration template for a codebook configuration,
   a configuration or configuration template for a Discontinuous Reception, DRX, configuration,
   a configuration or configuration template for a uplink/downlink, UL/DL, scheduling configuration,
   a configuration or configuration template for an antenna/antenna port configuration.
   a configuration or configuration template for a Demodulation Reference Signal, DMRS, configuration,
   a configuration or configuration template for a configured grant configuration,
   a configuration or configuration template for a data radio bearer configuration,
   a configuration or configuration template for any PHY, MAC and higher layer configuration entailed for transmission and/or reception of data,
for the measurement of the radio environment, the UE is configured by one or more of the following configurations or configuration templates:
   a configuration or configuration template for a Synchronization Signal Block, SSB,
   a configuration or configuration template for a Zero Power and Non-Zero Power Channel-State Information Reference Signals, CSI-RS,
   a configuration or configuration template for CSI Interference Measurement Reference Signals, CSI-IM RS,
   a configuration or configuration template for a phase tracking reference signal,
   a configuration or configuration template for a sounding reference signal,
   a configuration or configuration template for any reference signal,
   a configuration or configuration template for Quasi co-location, QCL, information between different reference signals,
   a configuration or configuration template for a measurement gap configuration,
   a configuration or configuration template for measurement quantities per beam/cell, metrics,
   a configuration or configuration template for measurement events, conditions and/or thresholds for layer 1, L1, and/or layer 3, L3, measurements,
for the feedback, the UE is configured by one or more of the following configurations or configuration templates:
   a configuration or configuration template for a time and frequency configuration of reporting, as well as sub-carrier spacing, a configuration or configuration template for defined reference signals,
   a configuration or configuration template for a group beam based reporting,
   a configuration or configuration template for a type of report-wide-band or sub-band,
   a configuration or configuration template for a Channel Quality Indicator/Rank Indicator/Precoding Matrix Indicator, CQI/RI/PMI, mode,
   a configuration or configuration template for a codebook type,
   a configuration or configuration template for measurement filtering rules.

In accordance with embodiments,
the wireless communication system is a 3rd Generation Partnership Project, 3GPP, system,
the configuration is a Radio Resource Control, RRC, configuration,
the protocol stack is the 5G, New Radio, NR, Radio Protocol Stack,
the first layer is the 5G RRC layer of the 5G NR Radio Protocol Stack,
the one or more second layers comprises one or both of the 5G MAC layer and the 5G PHY layer of the 5G NR Radio Protocol Stack, and
the control message comprises a DCI or a MAC CE or both.

In accordance with embodiments, the RRC configuration or the configuration template comprises one or more fields, which are defined using information elements, IEs, each IE includes one or more IE fields, and each IE field has one or more field values to be applied or used by the UE when performing the certain operation.

In accordance with embodiments, the UE is preconfigured with the configuration or the configuration template
at a time of initial connection with the wireless communication system, e.g., via a signaling in the first layer of a protocol stack of the wireless communication system,
at a time of provisioning the UE for operation with the wireless communication system, e.g., by inserting a Subscriber Identity Module, SIM, holding the configuration or the configuration template or by activating an embedded SIM, eSIM, holding the configuration or the configuration template, or
at a time of manufacturing the UE, e.g., by storing the configuration or the configuration template in a memory of the UE, like in an eSIM or in any other memory element.

In accordance with embodiments, the user device, UE, comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and entailing input from a gateway node at periodic intervals, or a mobile terminal, or a stationary terminal, or a cellular IoT-UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### First Aspect: Modify Existing Configurations—gNB

### Modify/Combine Higher Layer Configurations

The present invention provides a network entity for a wireless communication system, like a 3^{rd} Generation Partnership Project, 3GPP, system,
wherein the wireless communication system comprises one or more user devices, UEs, wherein the UE includes one or more UE configurations,
wherein the UE configuration
   is associated with one or more certain operations to be performed by the UE,
   defines one or more fields concerning the certain operation, and
   includes for each field one or more field values to be applied or used by the UE when performing the certain operation, and
wherein the network entity is to signal to one or more UEs one or more control messages, the control message
   including for one or more or all of the fields of a UE configuration one or more new field values to be used by the UE to obtain a new UE configuration by replacing the field value for a field in the UE configuration by a new field value from the control message, or
   including information for generating a new configuration using two or more of a plurality of the UE configurations.

### Second Aspect: Configuration Templates—gNB

### Populate/Combine Higher Layer Configuration Templates

The present invention provides a network entity for a wireless communication system, like a 3^{rd} Generation Partnership Project, 3GPP, system,
wherein the wireless communication system comprises one or more user devices, UEs, wherein the UE includes one or more UE configuration templates,
wherein the UE configuration template
   is associated with one or more certain operations to be performed by the UE,
   defines one or more fields concerning the certain operation, and
   includes for one, some or all fields a placeholder for one or more field values, and
wherein the network entity is to signal to one or more UEs one or more control messages, the control message
   including for one or more of the fields of a UE configuration template one or more field values to be used by the UE to generate a new UE configuration template by replacing in the UE configuration template the placeholder for a field by a field value from the control message, or
   including information for generating a new configuration template using two or more of a plurality of UE configuration templates.

### General Definitions Applying to all Previous Network Entities

In accordance with embodiments, the network entity is to send the one or more control messages in in a certain layer of a protocol stack of the wireless communication system, the certain layer of the protocol stack being
a first layer of the protocol stack used for transmitting one or more configuration messages, like the RRC layer, the control message being a further configuration message having a size smaller than a size of a configuration message, or
a second layer, like the PHY layer, being lower than the first layer.

In accordance with embodiments, the network entity is to signal to the UE an activation regarding the new UE configuration or new UE configuration template allowing the UE to make use of the new UE configuration or the new UE configuration template only responsive to the activation signaling.

In accordance with embodiments, the network entity is to send the activation only responsive to a signaling that the new UE configuration or new UE configuration template is completed.

In accordance with embodiments, the network entity comprises a base station or a user device, UE,
wherein the base station comprises one or more of the following: a macro cell base station, or a small cell base station, or a central unit of a base station, or a distributed unit of a base station, or an Integrated Access and Backhaul, IAB, node, or a road side unit, RSU, or a UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network, and
wherein the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and entailing input from a gateway node at periodic intervals, or a mobile terminal, or a stationary terminal, or a cellular IoT-UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### First & Second Aspects: System

The present invention provides a wireless communication system, like a 3rd Generation Partnership Project, 3GPP, system, comprising a one or more user devices, UEs, of the present invention and/or one or more network entities of the present invention.

### First & Second Aspects: Methods

### Operating a UE

### Change Field Values of a Higher Layer Configuration Via Lower Layer Control Message

The present invention provides a method for operating a user device, UE, for a wireless communication system, like a 3rd Generation Partnership Project, 3GPP, system, the UE comprising one or more antennas, a signal processor connected to the antenna, and one or more configurations, wherein the configuration
is associated with one or more certain operations to be performed by the signal processor,
defines one or more fields concerning the certain operation, and
includes for each field one or more field values to be applied or used by the UE when performing the certain operation,
wherein the method comprises:
operating the UE in accordance with the configuration, and
generating, by the UE, a new configuration by modifying the configuration by replacing the field value for a field in the configuration by a new field value.
   Combine Higher Layer Configurations into New Configuration

The present invention provides a method for operating a user device, UE, for a wireless communication system, like a 3rd Generation Partnership Project, 3GPP, system, the UE comprising one or more antennas, a signal processor connected to the antenna, and a plurality of configurations, wherein each configuration
is associated with one or more certain operations to be performed by the signal processor,
defines one or more fields concerning the certain operation, and
includes for each field one or more field values to be applied or used by the UE when performing the certain operation,
wherein the method comprises:
generating, by the UE, a new configuration using two or more of the plurality of configurations.
   Populate Higher Layer Configuration Template with Field Values

The present invention provides a method for operating a user device, UE, for a wireless communication system, like a 3^{rd} Generation Partnership Project, 3GPP, system, the UE comprising one or more antennas, a signal processor connected to the antenna, and one or more configuration templates, wherein the configuration template
is associated with one or more certain operations to be performed by the signal processor,
defines one or more fields concerning the certain operation, and
includes for one, some or all fields a placeholder for one or more field values,
wherein the method comprises:
generating, by the UE, a configuration for performing the certain operation by replacing in the configuration template the placeholder for a field by a field value.
   Combine Higher Layer Configuration Templates into New Template

The present invention provides a method for operating a user device, UE, for a wireless communication system, like a 3^{rd} Generation Partnership Project, 3GPP, system, the UE comprising one or more antennas, a signal processor connected to the antenna, and a plurality of configuration templates, wherein each configuration template
is associated with one or more certain operations to be performed by the signal processor,
defines one or more fields concerning the certain operation, and
includes for one, some or all fields a placeholder for one or more field values,
wherein the method comprises:
generating a new configuration template using two or more of the plurality of configuration templates.

### Operating a gNB

### Modify/Combine Higher Layer Configurations

The present invention provides a method for operating a network entity for a wireless communication system, like a 3^{rd} Generation Partnership Project, 3GPP, system, wherein the wireless communication system comprises one or more user devices, UEs, wherein the UE includes one or more UE configurations, and wherein the UE configuration
is associated with one or more certain operations to be performed by the UE,
defines one or more fields concerning the certain operation, and
includes for each field one or more field values to be applied or used by the UE when performing the certain operation, and
wherein the method comprises:
signaling, by the network entity, to one or more UEs one or more control messages, the control message
   including for one or more or all of the fields of a UE configuration one or more new field values to be used by the UE to obtain a new UE configuration by replacing the field value for a field in the UE configuration by a new field value from the control message, or
   including information for generating a new configuration using two or more of a plurality of the UE configurations.

### Populate/Combine Higher Layer Configuration Templates

The present invention provides a method for operating a network entity for a wireless communication system, like a 3^{rd} Generation Partnership Project, 3GPP, system, wherein the wireless communication system comprises one or more user devices, UEs, wherein the UE includes one or more UE configuration templates, wherein the UE configuration template
is associated with one or more certain operations to be performed by the UE,
defines one or more fields concerning the certain operation, and
includes for one, some or all fields a placeholder for one or more field values, and
wherein the method comprises:
signaling, by the network entity, to one or more UEs one or more control messages, the control message
   including for one or more of the fields of a UE configuration template one or more field values to be used by the UE to generate a new UE configuration template by replacing in the UE configuration template the placeholder for a field by a field value from the control message, or
   including information for generating a new configuration template using two or more of a plurality of UE configuration templates.

### First & Second Aspects: Computer Program Product

Embodiments of the first aspect of the present invention provide a computer program product comprising instructions which, when the program is executed by a computer, causes the computer to carry out one or more methods in accordance with the present invention.

Embodiments of the present invention are now described in more detail, and it is noted that the subsequently described aspects and embodiments may be implemented independent from each other or may combined with each other.

### First Aspect—Modifying/Combining Existing Configurations

FIG. 11 illustrates an embodiment of a user device in accordance with embodiments of the first aspect of the present invention. The user device, UE, 400 includes a signal processor 402 and one or more antennas 404. The signal processor 402 and the antenna 404 are connected, as is schematically illustrated at 406. Further, the UE 400 comprises one or more configurations, as is indicated at 408. For example, the one or more configurations 408 may be stored in a memory or other storage device of the UE 400. The UE configuration, which may be an RRC configuration, may be associated with one or more certain operations or functions to be performed by the UE using its signal processor 402. The configuration defines one or more parameters or fields concerning the certain operation or function to be performed by the UE and includes, for each field or parameter one or more field values or parameters to be employed, applied or used by the UE 400 when performing the operation or function. In other words, on the basis of the one or more configurations 408, the UE performs a certain operation, i.e., operates in accordance with the configuration 408.

### First Embodiment—Modifying Existing Configurations

In accordance with a first embodiment of the first aspect of the present invention, to avoid the drawbacks of conventional approaches using a processing-heavy configuration 408, the UE 400 generates a new configuration by modifying the existing configuration by replacing a field value for one or more of the fields in the existing configuration by a new field value. In other words, rather than requesting a complete new configuration, UE 400 is capable to modify an existing configuration by replacing one, some or all of the field values included in the existing configuration without the need for receiving a complete new configuration message, like a full RRC reconfiguration message as it is conventionally provided in 3GPP communication networks. It is noted that 3GPP networks also support delta RRC signaling in some cases, such as the case of intra-system handover, HO, when there is a modification or change of a Secondary Node in Dual Connectivity or during RRC Resume. However, conventionally, if there is a change in the configuration covered by a listed field, the full configuration for that field is used.

In accordance with embodiments, UE 400 may generate the new configuration by selecting for one or more or all fields of the existing configuration one or more new field values in accordance with one or more criteria, for example dependent on changes in the UE's environment, like an increased number of interfering UEs or a drop in channel quality or as a result of a change in one of the parameters when a UE is connected to multiple TRPs or, generally, due to a change in one of the MIMO-related parameters or the like.

In accordance with yet other embodiments, UE 400 may change the one or more field values of an existing configuration responsive to one or more control messages. In the embodiment of FIG. 11, UE 400 is shown to be part of a wireless communication network, like the one described above with reference to FIG. 1(A) and FIG. 1(B) and is assumed to be served by a base station or gNB 410 including a signal processor 412 connected, as is indicated at 414 to one or more antennas 416 of the gNB 410. UE 400 and gNB 410 communicate over the radio link using the Uu interface 418, and UE 400 may receive from gNB 410 one or more control messages over the Uu interface 418 including for one or more or all of the fields of an existing configuration one or more new field values. Responsive to receiving the control message, UE 400 replaces in the existing configuration one or more values for the respective fields. In accordance with other embodiments, the control message may also come from another UE, like a sidelink UE 420 with which UE 400 communicates over the sidelink or PC5 interface 422.

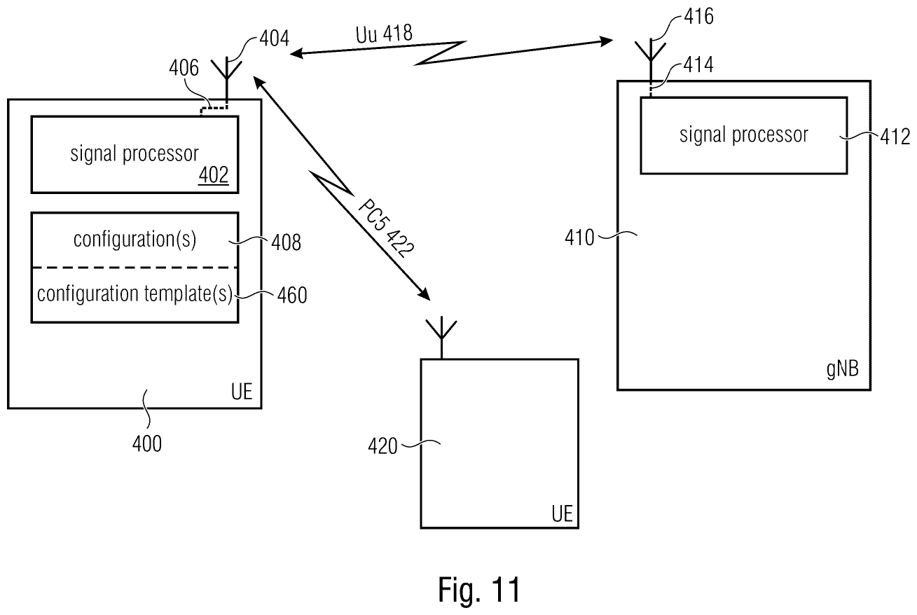

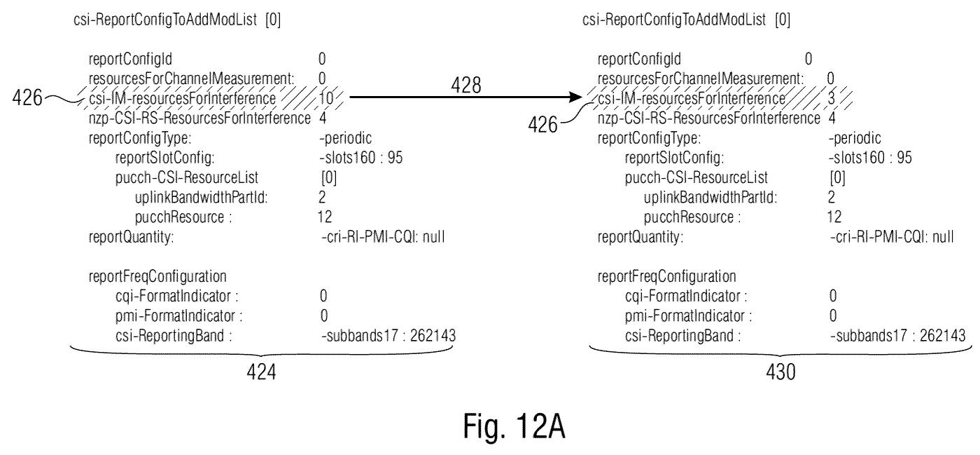

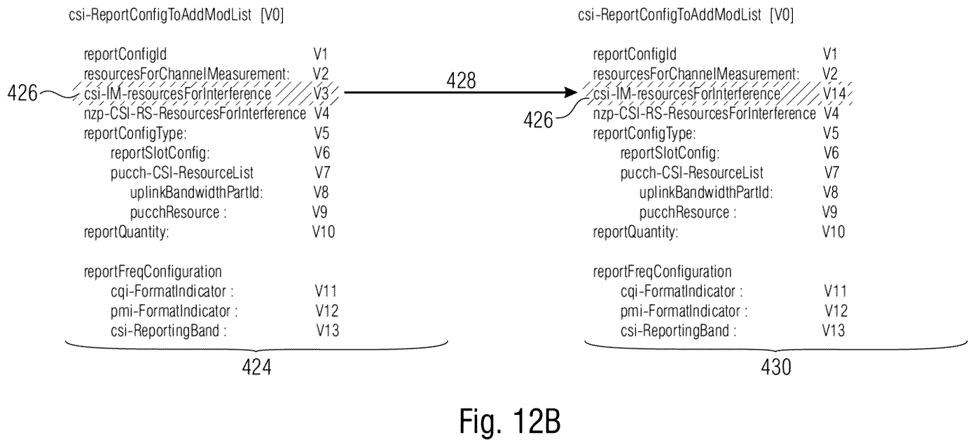

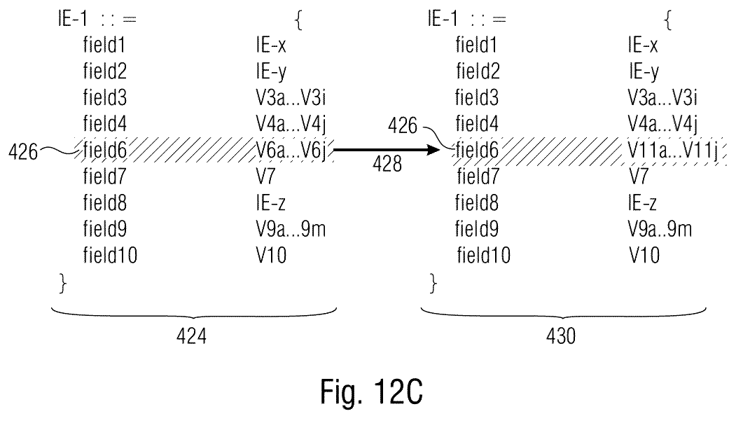

FIG. 12(A) to FIG. 12(C) illustrate examples how, in accordance with embodiments of the first aspect of the present invention, an existing UE configuration may be modified. FIG. 12(A) illustrates as an example the reporting configuration of FIG. 3 and FIG. 4(A) to FIG. 4(C), more specifically the configuration and associated parameters values as decoded at UE 400. Thus, FIG. 12(A) illustrates at 424 an existing configuration for which fifteen IEs or parameters are indicated, namely:

```
- csi-ReportConfigToAddModList
- reportConfigId
- resourcesForChannelMeasurement
- nzp-CSI-RS-ResourcesForInterference
- csi-IM-resourcesForInterference
- reportConfigType
  ∘ reportSlotConfig
  ∘ pucch-CSI-ResourceList
    ▪ uplinkBandwidthPartId
    ▪ pucchResource
- reportQuantity
- reportFreqConfiguration
  ∘ cqi-FormatIndicator
  ∘ pmi-FormatIndicator
  ∘ csi-ReportingBand
```

The current configuration 424 with which the UE 400 was preconfigured or configured by the gNB included for each of the parameters respective values. Conventionally, when it is desired to change one parameter value or field value, for example the value associated with the IE csi-IM-resourcesForInterference, a full RRC reconfiguration is to be carried out and the entire configuration is to be replaced by a new configuration received over the RRC layer from the gNB. Clearly, this approach is not very flexible and quick, especially in situations in which the UE or another entity in the network determines that it is advantageous to modify only a single parameter value, for example, the value “10” associated with the IE csi-IM-resourcesForInterference because either the UE itself or another entity, like the gNB 410 or the sidelink UE 420, determined that an interference situation in the vicinity of UE 400 changed so that other resources for the interference management are to be considered in the measurement configuration. In accordance with the inventive approach, the UE 400 either on its own or responsive to a control message from the gNB 410 or the UE 420 modifies only the value “10” for the IE 426, as is indicated at 428 schematically, thereby yielding a new configuration 430 corresponding to the existing configuration 424 except for the value of IE 426 now being changed to “3”. FIG. 12(A) represents a case when within the report 0, the interference measurement resource is changed. This change is suitable for an indication via DCI, assuming an interference resource with the new value was previously defined.

It is noted that present invention is not limited to the embodiment of FIG. 12(A). The respective IEs may be associated with any valid value or valid parameter, e.g., as specified in the specification. FIG. 12(B) illustrates a more generic embodiment, similar to FIG. 12(A), however, the respective IEs in the original configuration 424 are associated with values or parameters V1 to V13. Of the original IEs, the IE 426 is to be modified, as is indicated at 428 so that, in the new configuration 430, the IE 426 is associated with the new value or the new parameter V14.

Moreover, the inventive approach is not limited to configurations comprising a plurality of IEs. It is equally applicable to configurations having only one IE or to individual IEs belonging to an existing configuration. FIG. 12(C) illustrates an embodiment of an existing IE having the fields field1 to field10, each associated with a certain parameter, like a reference to another IE (see field1, field2 and field8 associated with IE-x, IE-y and IE-z, respectively) or a certain value (see field3, field4, field5, field6, field7, field9, field10). One or more of the fields in the original or existing IE may be modified in accordance with the inventive approach, e.g., as depicted in FIG. 12(C), filed6 424 may be modified 428 such that, in the new IE 430, the associated values are changed from V6a . . . . V6j to V11a . . . . V11j.

In accordance with embodiments in which the modification of the existing configuration 424 is performed responsive to one or more control messages, the signaling of the one or more control messages may be performed on a layer of the protocol stack of the wireless communication system that is different from a layer that is used for configuring the UE 400 with a complete configuration. For example, UE 400 may be configured by the gNB 410 with an existing RRC configuration 424 using RRC layer or L3 signaling, and the control messages may be a MAC CE and/or a DCI transmitted in a lower layer using, for example, L1 signaling in the PHY layer or L2 signaling in the MAC, layer, so that by means of the lower layer signaling a quick change or modification of the existing configuration 424 into the new configuration 430 is achieved without the need for an extensive signaling over the RRC layer.

In accordance with other embodiments, the control messages may also be transmitted on the RRC layer, however, rather than using a conventional configuration/reconfiguration message as is used for providing a UE with an RRC configuration, like a conventional RRC reconfiguration message, a smaller sized configuration message may be used in the RRC layer so that also a quick change of the parameter values or field values is achieved.

Thus, embodiments of the first aspect of the present invention provide for enhancements and improvements of wireless communication systems by enabling more flexible configurations and operations of such systems making use, for example, of the dynamic signaling using DCI messages that carry dynamic parameters, namely the values to be modified in an existing configuration as described above with reference to FIG. 12(A) to FIG. 12(C). Embodiments of the first aspect of the present invention meet the need for a more dynamic signaling of a transmission/reception configuration or a configuration of a measurement and reporting by expanding the known framework of MAC CE/DCI signaling to a greater range of parameters in addition to using RRC signaling that has greater overhead and results in a longer processing delay. For example, the more dynamic MAC CE/DCI approach for modifying existing configurations may be applied to transmission/reception configurations/reconfigurations, for example in case a gNB needs to change a MIMO-related parameter. Such a mechanism may be used to instruct a multi-panel UE on an array panel activation or deactivation, similar to instructing a UE to perform beam switching (through MAC CE/DCI), or indicating to the UE the appropriate uplink beam for SRS transmission, using DCI. Other examples may refer to measurement and reporting configurations, for example a UE may be instructed to switch between measurements of different CSI-RSs or between SSB and CSI-RS, or to reporting/UE feedback configurations, for example in case a report type on the same resource needs to be changed (e.g. semi-persistent to periodic), or time offsets need to be modified.

In accordance with embodiments, when considering a reporting configuration, in a first communication, the UE 400 may be provided with a default structure and elements for measurement and reporting, for example by providing a UE configuration as described above with reference to FIG. 3 and FIG. 4(A) to FIG. 4(C). In accordance with the first aspect of the present invention, at a later stage, for example when the UE itself or another entity in the network determines the need for changing one or more of the parameter values, the reporting configuration is changed by changing or modifying one or more of the field values of the parameters of the reporting configuration.

In accordance with embodiments, the field values may be modified or changed using DCI messages. For example, in case one or more IEs entail frequent and fast changes, they may be defined in a way that such changes may be performed by signaling through the use of lower layer signaling, for example by DCI or MAC CE/DCI signaling without resorting to a RRC reconfiguration. Naturally, the RRC IEs are defined and have been signaled earlier to the UE, for example using RRCsetup or RRCReconfiguration messages, as is conventionally done. Taking as an example the above-described CSI-ReportConfig, in case there is a requirement to refer to a different measurement resource, without changing other parameters in the already defined report for a UE, for example reportConfigId 0, this may be signaled through DCI. Another example is a request for an aperiodic reporting, which may only refer to differential measurements with respect to a periodic report on the same resource. In such a case, if DCI format DCIxx on PDCCH that has been extended to support the inventive approach is received, based on the C-RNTI the UE may descramble the message and read the PDCCH message so as to determine which different resource to use in the defined report configuration and which differential measurement is to be reported on in an aperiodic manner.

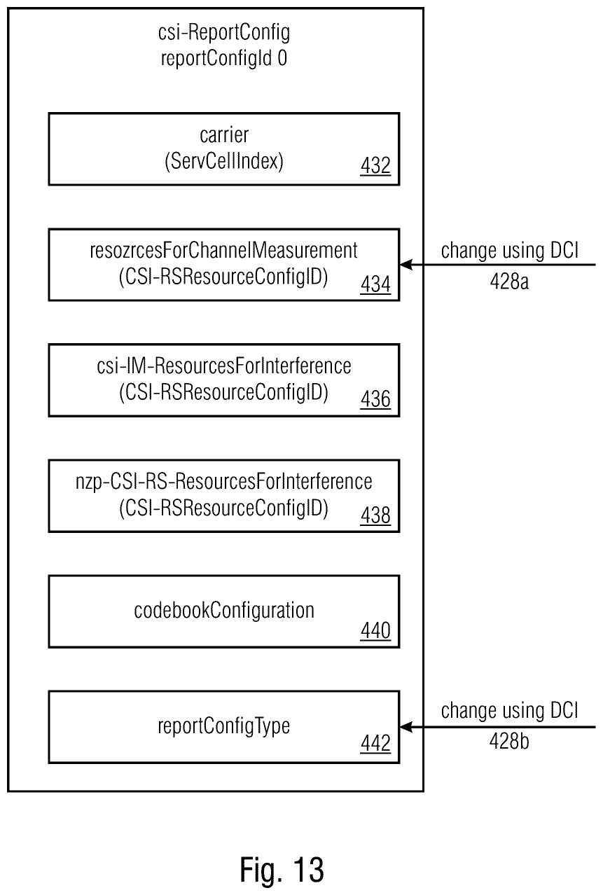

FIG. 13 illustrates the just-mentioned concept of changing a field value for a certain field of a configuration using lower layer signaling. FIG. 13 illustrates the CSI-ReportConfig 1E including the parameters or IEs carrier 432, resource for channel measurement 434, csi-IM-ResourcesForInterference 436, nzp-CSI-RS-ResourcesForInterference 438, codebook configuration 440, and reportConfigType 442. It is assumed that among the IEs 432 to 442, a change in IE 434 and a change in IE 442 is desired, and as is indicated at 428a and 428b, the respective field values associated with the IEs 434 and 442 are changed by using DCI in a way as just described, namely by providing a specific DCI format that is descrambled by UE 400 and allows the UE to determine the way the IEs field values are to be modified.

### Second Embodiment—Combining Existing Configurations

In accordance with a second embodiment of the first aspect of the present invention, existing UE configurations may be combined into a new configuration. For example, when considering FIG. 11, UE 400 may hold a plurality of configurations 408 and decide, either on its own or responsive to control messages, in a similar way as described above with reference to the first embodiment, to generate a new configuration using two or more of the plurality of existing configurations 408.

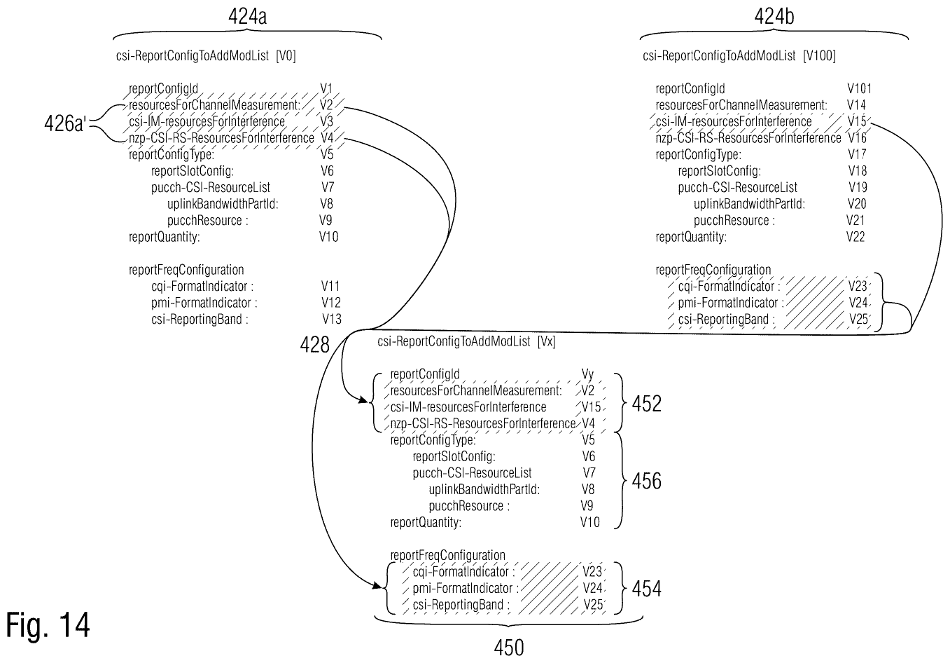

FIG. 14 illustrates an example for creating a new configuration in accordance with the second embodiment of the first aspect of the present invention. In the example of FIG. 14 it is assumed that UE 400 is configured with a first UE configuration 424a and with a second UE configuration 424b. Both configurations are assumed to be measurement and reporting configurations similar to FIG. 3 and FIG. 4(A) to FIG. 4(C), however, it is assumed that the existing configuration 424a operates on the basis of reportConfigId V0 and includes corresponding IEs or parameters and their values, such as

- resourcesForChannelMeasurement
- nzp-CSI-RS-ResourcesForInterference
- csi-IM-resourcesForInterference.

The second existing configuration 424b operates on the basis of reportConfigId V100 and includes the same IEs or parameters, with different values.

In case UE 400 or another entity in the system determines that it is desired to perform a measurement and reporting using the resources (not the resource sets) indicated in configuration 424a and in configuration 424b, rather than conventionally performing an RRC reconfiguration and sending a new configuration to the UE, in accordance with embodiments, the UE selects from the respective existing configurations 424a and 424b the parameters or fields of interest, namely IEs 426a′ from existing configuration 424a and IEs 426b′ from the second existing configuration 424b which are combined, as is indicated at 428 into the new configuration 450 now including the IEs 452 and 454, with the remaining IEs 546 taken from the configuration 424a.

Thus, in accordance with embodiments of the first aspect of the present invention, a new configuration may be generated from existing configurations. In accordance with embodiments, the respective IEs may be determined explicitly in the control message or by the UE 400, however, in accordance with other embodiments, a certain description of a desired operation may be used so as to allow the UE to determine which elements from the existing configurations are to be combined. For example, when considering FIG. 14, a description of a new measurement configuration and reporting may be included in the one or more control messages and the description may indicate that it is desired to obtain measurements including channel measurements and interference measurements using nzp-CSI-Resources from reportConfigId V1 and interference measurements from reportConfigId V101, using time domain report configuration from reportConfigId V1 and frequency domain report configuration from reportConfigId V101. Clearly, the combination of indicated resources needs to be suitable for a particular time-domain and frequency-domain reporting configuration, or any other configuration as a result of change due to combining different configurations. A combination of different configurations may also be done with respect to an existing configuration and a previous configuration on the same e.g. BWP. For example, an existing configuration may operate on the basis of CSI-RS resources for channel and interference measurement, whereas some previous configurations (at −x slots) on the same BWP included besides channel measurement, CSI-IM resources for interference measurement. A network entity may, therefore, determine, that it may be beneficial to combine measurements and report from the existing and a previous configuration, and instruct the UE via a control signal to combine such configurations. A control signal may be in a form of a simple RRCReconfiguration message, which may now include a new IE to instruct combining of particular configurations (e.g. report configurations using csi-ReportConfigToAddModList) while including only pointers towards IEs that need to be combined. This causes the UE to search for respective IEs in the existing or previous indicated configurations that may provide the desired information or that may be combined so as to obtain the desired information thereby generating the new configuration 450.

Once the UE created the new configuration 450 having the values V2, V15, V4-V10, and V23-V25, the UE 400 may start operating in accordance with the new configuration 450 for performing measurements both on the channel quality and the interference situation.

In accordance with embodiments, UE 400 may modify the values for the fields 452 of the new configuration 450 in a similar way as described above with reference to the first embodiment, namely by determining, either on its own or responsive to a control message, new values for one or more of the fields, as has been described in more detail above with reference to FIG. 12(A) to FIG. 12(C).

In accordance with embodiments, UE 400 may create the new configuration by one or more of the following:
Adding selected fields to one of the plurality of configurations to obtain the new configuration.
Copying one of the plurality of configurations and add the fields to the copied configuration, thereby generating the new configuration and maintaining the original configuration.
Combining selected fields into the new configuration.
Exchanging or sorting selected fields or IEs into the new configuration. The order may indicate a priority for, e.g., processing and in decision making if ambiguity happens along a process.
Fusing selected fields or IEs into a new field or IE into the new configuration. For example, if the old fields are voltage U and current I, a new fused field may be created, e.g., resistance R=U/I or power P=U*I, wherein the old values before the fusion may not be reversely obtained after the fusion.

### Second Aspect—Populating/Combining Configuration Templates

Embodiments of a second aspect of the present invention are now described, in accordance with which a UE is provided that includes a plurality of so-called configuration templates having one or more fields associated with a placeholder value. FIG. 11 illustrates the UE 400 including in addition to or instead of the one or more configurations 408 one or more configuration templates 460. A configuration template may be associated with one or more certain operations or functions to be performed by the UE 400, for example by using its signal processor 402. The template defines one or more fields or information elements related to or concerning the certain operation or function to be performed. Other than a conventional configuration, the configuration template does not include any valid field values for one, some, or all parameters or fields, rather, for one, some, or all parameters or fields of the template, only placeholders are provided which have no meaning to or are invalid for the UE 400, i.e., the placeholder may be a value on the basis of which the UE 400 is not capable to operate.

### First Embodiment—Populating Existing Configuration Templates

In accordance with a first embodiment of the second aspect of the present invention, UE 400 generates a configuration to be used for operating the UE 400 in accordance with a desired operation or function by populating the configuration template, for example, by replacing the placeholders for the one or more fields by a specific or valid field value, i.e., with a value on the basis of which the UE may operate. In the same way as described above with regard to the first embodiment of the first aspect, also in the first embodiment of the second aspect, the actual or valid field values to be used as replacement for the placeholders may be obtained from one or more messages the UE 400 receives from one or more other entities of the network, like the gNB 410 and/or the UE 420. In accordance with other embodiments, the UE may select the field values for the one or more fields of the configuration template on its own responsive to one or more criteria, and the field values actually selected may also depend on the criteria which causes the UE 400 to populate the configuration template with the field values.

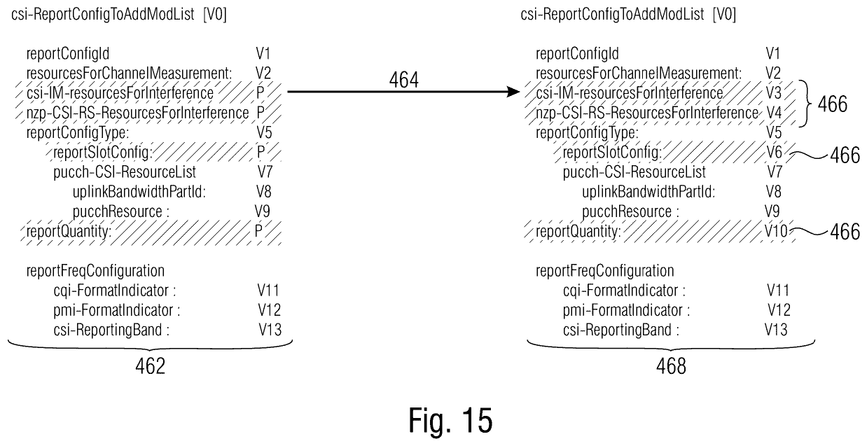

FIG. 15 illustrates an example for populating a template in accordance with the first embodiment of the second aspect of the present invention. FIG. 15 illustrates a configuration template 462, like a measurement configuration template similar to the measurement configuration of FIG. 3 and FIG. 4(A) to FIG. 4(C). FIG. 15, similar to FIG. 14, illustrates as an example the measurement and reporting configuration of FIG. 4(A) to FIG. 4(C), more specifically the configuration and associated parameters values as defined in the template at the UE 400. Thus, FIG. 15 illustrates the configuration template 462 having the following fifteen IEs or parameters:

```
- csi-ReportConfigToAddModList
- reportConfigId
- resourcesForChannelMeasurement
- nzp-CSI-RS-ResourcesForInterference
- csi-IM-resourcesForInterference
- reportConfigType
  ∘ reportSlotConfig
  ∘ pucch-CSI-ResourceList
    ▪ uplinkBandwidthPartId
    ▪ pucchResource
- reportQuantity
- reportFreqConfiguration
  ∘ cqi-FormatIndicator
  ∘ pmi-FormatIndicator
  ∘ csi-ReportingBand
```

As may be seen from FIG. 15, the template 462 is not a configuration on the basis of which UE 400 is capable to operate for performing a certain function or operation, because at least some of the field values are not populated with respective values but are populated by placeholders indicated for the IES nzp-CSI-RS-ResourcesForInterference, csi-IM-resourcesForInterference, reportSlotConfig and reportQuantity in FIG. 15 by “P”. It is noted that also all of the IEs in the template 462 may have associated therewith, initially, a placeholder. Also, more or less IEs may be associated with a placeholder. In accordance with embodiments of the second aspect of the present invention, UE 400 may populate the template 462 with field values, for example, responsive to one or more control messages or on its own, as is indicated at 464, thereby associating, in the example of FIG. 15, the IEs nzp-CSI-RS-ResourcesForInterference, csi-IM-resourcesForInterference, reportSlotConfig and reportQuantity with the values V3, V4 and V6 and V10, as is indicated at 466, thereby creating a new configuration 468 on the basis of which UE 400 is capable to operate, for example to perform desired measurements/reportings.

In accordance with embodiments, UE 400 may operate such that when creating the new configuration 468, initially, the original template 462 is copied, and either in the original version of the template or in the copied version thereof, the respective placeholders P are populated by the values V3, V4 and V6 and V10 thereby allowing UE 400 to generate a further new configuration on the basis of the original template 462.

Once the new configuration 468 has been created by UE 400 by populating the respective placeholders P in the template with values V3, V4 and V6 and V10, UE 400 may start using the new configuration 468, i.e., may start to operate or function in accordance with the new configuration.

UE 400 may start immediately with the use of the new configuration or with a delay, in the same way as described above with reference to the first aspect of the present invention.

Moreover, in accordance with further embodiments, the new configuration 468 may be modified in accordance with the principles of the first aspect of the present invention.

In accordance with the first embodiment of the second aspect of the present invention, the configuration templates may actually be the information elements, IEs, defined in the RRC messages already known, i.e., the respective IEs in the RRC messages may be considered as a kind of template or sub-template for using structured data types. For providing the templates to the UE, the respective RRC messages may be modified in such a way that some or all IEs or fields are indicated as optional so that the RRC message used for configuring the UE 400 contains fields or IEs having values that are currently invalid for use by the UE and are meant to be set up or changed, for example, by the control messages, like the DCI message, or by the UE on its own.

The present invention is not limited to the use of conventional IEs as template, rather, the inventive concept of providing a template or a template configuration includes a template that stores a set of fields or parameters that are not necessarily closely related. Each template may be provided with an identification or ID, and on the basis of the IDs respective templates may be linked or associated with each other. For example, a template may be cell or TRP-specific or even band-specific. By means of the template ID, a template may be linked or associated with multiple TRPs, cells, or bands. Also, templates may be provided that contain IEs for uplink and downlink separately. For example, the templates may be provided using a conditional pre-configuration IE which includes a condition for an action. For example, the condition may be a lower layer signal, such as a DCI or a combination of MAC CE and DCI or it may be a connection to a particular beam or a cell or a TRP or the activation of a particular bandwidth part. The condition may be used for activating/deactivating or for combining the respective templates or for selecting particular fields from the available templates.

### Second Embodiment—Combining Existing Configuration Templates

In accordance with the first embodiment of the second aspect of the present invention, one or more templates exist which may be populated by the UE with respective valid parameter values or field values so as to obtain one or more configurations on the basis of which the UE may function or operate. If a combination of specific templates is determined to be frequently used, in accordance with a second embodiment of the second aspect of the present invention a new template may be defined on the basis of the existing configuration templates in the UE 400. In other words, UE 400 may generate a new configuration template using two or more of the plurality of templates 460 with which the UE 400 is configured or preconfigured.

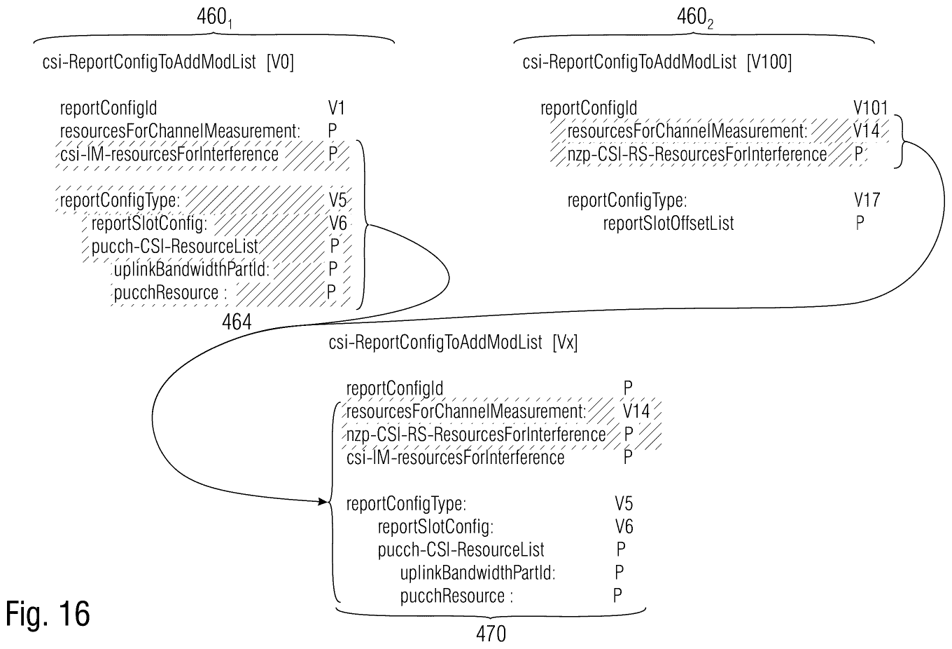

FIG. 16 illustrates an example for the second embodiment of the second aspect of the present invention. A first template 460₁ and a second template 460₂ are shown, which are similar to the template 462 illustrated in FIG. 15 and are based on the configuration IEs described above with reference to FIG. 4(A) to FIG. 4(C). Both templates define reporting configurations to be performed by UE 400. The first template 460₁ defines resources:

- resourcesForChannelMeasurement
- csi-IM-resourcesForInterference

The second template 460₂ defines the following resources:

- resourcesForChannelMeasurement and
- nzp-CSI-RS-ResourcesForInterference

Furthermore, the first template 460₁ defines periodic type reporting (V5) and associated IEs, whereas second template 460₂ defines aperiodic reporting (V17) and associated IEs. For example, when determining that measurements and reporting of both the RS and IM resources are used frequently, UE 400 may decide to create a new template. For example, UE 400 may decide that a new template 470 is to be created dependent on certain criteria, for example, when determining that it was entailed to perform measurements and reporting on both the RS resources and the IM resources repeatedly on the basis of the RS-resources and on the basis of the IM resource. Rather than populating the first and second templates 460₁ and 460₂ repeatedly, UE 400 may decide to create the new template 470 using the first and second templates 460₁ and 460₂. For example, UE 400 may use from the first existing template 460₁ the respective parameters or IEs associated with the RS resources, e.g., csi-IM-resourcesForInterference and reportConfigType, and from the second existing template 460₂ the respective parameters or IEs associated with the resourcesForChannelMeasurement with the value V14 and nzp-ResourcesForInterference.

As mentioned above, UE 400 may create or generate the new configuration template 470 on the basis of certain criteria, for example in case the UE 400 determines that certain parameters from different configuration templates are repeatedly used or in case it turns out that a certain measurement and report is requested to be performed by the UE which entails different resources as explained above. In accordance with other embodiments, rather than deciding about the generation of the new template by the UE, UE 400 may also receive one or more control messages from the other network entities, for example, from the gNB 410 and/or the UE 420 illustrated in FIG. 11. The control message may include either a description of what function is to be achieved by the UE in accordance with the new template or by indicating explicitly what templates and/or what fields or parameters of several templates are to be combined. The one or more network entities providing the control message may determine the need for creating a new template in a similar way as UE 400, for example, by determining that, when considering the embodiment of FIG. 16, that the same resources are requested to form the basis for a measurement repeatedly, which are present in different existing configuration templates.

Thus, in accordance with embodiments, UE 400 may generate the new configuration template by simply combining one or more fields from existing templates, for example, on the basis of information in the control message or on the basis of certain criteria determined by the UE. In other embodiments, rather than explicitly indicating fields to be combined, a more general description may be provided or determined by the UE on the basis of which UE 400 may determine how the new template has to look like. For example, when concerning the measurement/reporting configuration templates, UE 400 may determine or receive a description that it is desired to provide some statistical values, like an average value or a standard deviation or a peak to average ratio regarding certain measurements, and among the existing configuration templates 460, there may be different templates including IEs or parameters allowing for such operations which may then be combined by UE 400 into a new template.

In accordance with embodiments, once a new template 470 is created by UE 400, UE 400 may report the new configuration template 470 to the one or more network entities, like the gNB 410 and/or the sidelink UE 420.

Moreover, once created, UE 400 may populate the newly generated template 470 in a way as described above with reference to FIG. 15 thereby creating a new configuration on the basis of the new configuration template that the UE 400 may use for performing a certain operation or function as described above.

### General

So far, first and second embodiments of the second aspect have been described in detail. In the following, further embodiments of the second aspect are described which apply equally to the first embodiment concerning the populating of a configuration template, and to the second embodiment concerning the creation of a new configuration using existing configuration templates.

In accordance with the second aspect of the present invention, as described above, UE 400 may be provided with respective templates or configuration templates 460, and such templates 460 may be provided using an information element which is also referred to as “conditionally configured IE” which may include a certain condition for performing a certain action. For example, the condition may include a lower layer signal, such as a DCI or a combination of a MAC CE and DCI, or it may be a certain situation, like the connection to a particular beam or to a particular cell or to a particular transmission/reception point, TRP, or an activation of a particular bandwidth part, BWP. The condition may be used for activating or deactivating the template, wherein activating the template includes the above-described way of populating the placeholders (see FIG. 15) with respective field values for the fields or parameters or IEs included in the template. Also, the condition may cause the combining of one or more of the templates 460 as described above with reference to FIG. 16. Thus, in accordance with the second aspect of the present invention, rather than conventional approaches, templates are provided in the UE which may be activated/deactivated and combined as described above with reference to FIG. 15 and FIG. 16 and which may be provided to the UE using an RRC reconfiguration information element providing for a conditional pre-configuration, and a condition and action to be taken may be signaled for example in the form of a trigger signal, such as a MAC CE/DCI signaling.

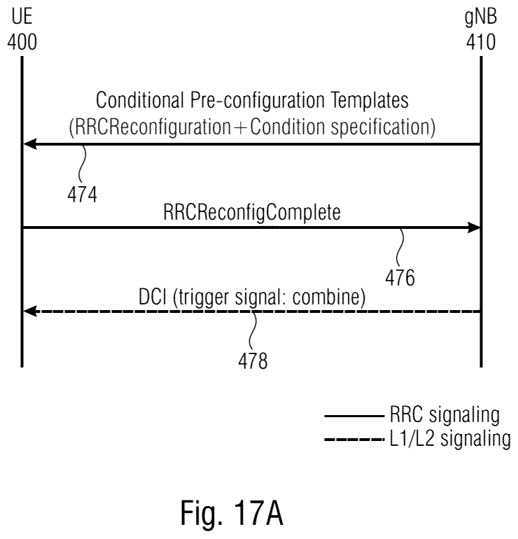

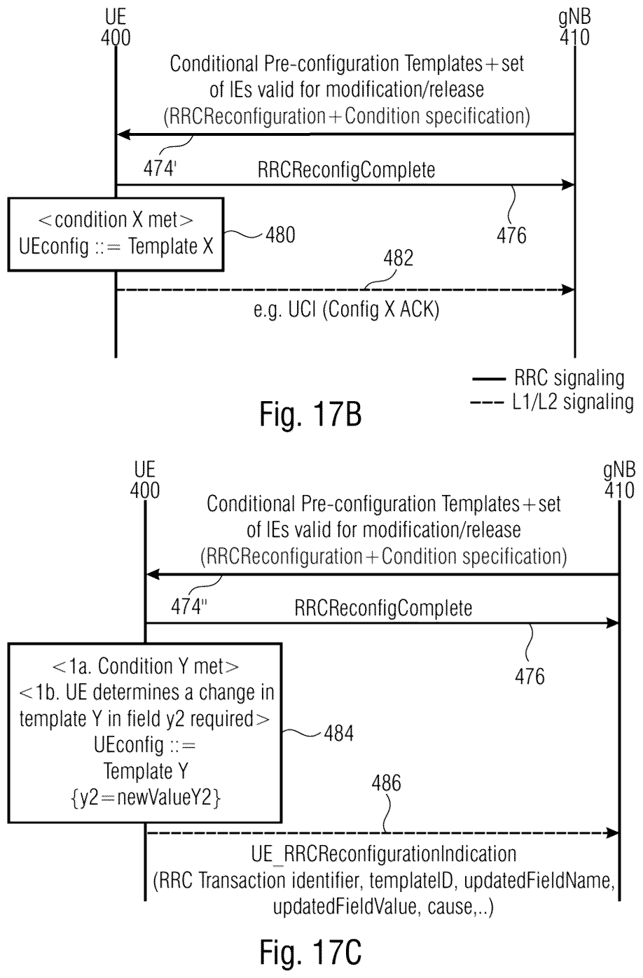

FIG. 17(A) illustrates an example of the above-described approach of configuring the UE 400 with templates in more detail. FIG. 17(A) illustrates how templates are sent via an RRC message and combined with each other responsive to a DCI as a trigger signal. FIG. 17(A) illustrates a situation in which UE 400 receives from the gNB 410 an RRC configuration including a condition specification, as is indicated at 474. Thus, at 474 in FIG. 17(A), UE 400 is configured with the plurality of templates 460 also referred to as conditional pre-configuration templates, and once UE 400 received the templates, the RRC ReconfigComplete message is returned to the gNB 410 as is illustrated at 476. At a later time, for example responsive to a certain situation determined by the gNB 410, a DCI may be sent which has a specific format for UE 400 which informs UE 400 that an existing template is to be populated with certain values or that a new template is to be created on the basis of the existing templates, i.e., the DCI may carry a trigger signal causing UE 400 to, e.g. combine some of the preconfigured configuration templates 460, as is indicated at 478. In this case, gNB 410 does not expect any further response from UE 400 in relation to a reconfiguration.

FIG. 17(B) illustrates a further example of the above-described approach of configuring the UE 400 with templates, however, other than in FIG. 17(A) where the configuration was done responsive to a DCI, in FIG. 17(B), the preconfigured templates are sent via an RRC message and later applied responsive to a certain condition. FIG. 17(B) illustrates a situation in which UE 400 receives from the gNB 410 an RRC configuration including a condition specification, as is indicated at 474′. Thus, at 474′ in FIG. 17(B), UE 400 is configured with the plurality of templates 460 also referred to as conditional pre-configuration templates and with a set of IEs that are valid for modification or release, i.e., IEs in the templates that may be modified or no longer be used. Once UE 400 received the templates, the RRC ReconfigComplete message is returned to the gNB 410 as is illustrated at 476. At a later time, responsive to determining 480 that a certain condition or trigger X is met, like those described above, the UE 400 populates an existing template with certain (known) values for creating the new configuration X or uses the preconfigured template X as is, i.e. there is no requirement to change any of the IEs or the values of template X. AT 482, UE 400 may acknowledge the new configuration Config_X towards the gNB 410, e.g., by sending Uplink Control Information including the acknowledgement. It should be noted that gNB 410, as a part of a condition, may request an acknowledgement, following the application of a template, or it may be defined in the specification.

FIG. 17(C) illustrates a further example of the above-described approach of configuring the UE 400 with templates. In FIG. 17(C) templates are sent via an RRC message and modified responsive to a certain condition. FIG. 17(C) illustrates a situation in which UE 400 receives from the gNB 410 an RRC configuration including a condition specification, as is indicated at 474″. Thus, at 474″ in FIG. 17(B), UE 400 is configured with the plurality of templates 460 also referred to as conditional pre-configuration templates and with a set of IEs that are valid for modification or release, i.e., IEs in the templates that may be modified or no longer be used. Once UE 400 received the templates, the RRC ReconfigComplete message is returned to the gNB 410 as is illustrated at 476. At a later time, responsive to determining 484-1a that a certain condition or trigger Y is met, like those described above, the UE 400 determines 484-1b that due to the condition/trigger the provided template Y may be used, but a certain field in the template needs to be changed, e.g., a field y2 in a template Y. UE 400 modifies the field Y2 in the template Y, thereby creating a new template and informs 486 the gNB 410. Hence, the feedback this time is a L3 message, a new type of RRC message, a message from UE to gNB, UE_RRCReconfigurationIndication, The message provides the gNB information with the reference to the related RRCReconfiguration message using its transaction identifier, and also refers to a template ID, a changed field and its new value, and a cause of such a change, where the cause of change is expected to be, e.g. in a specification.

In accordance with the second aspect of the present invention, the use of template configurations allows, in accordance with embodiments, for improvements in the feedback provided by a user device to the network, for example, by using a certain feedback template base design or feedback template base configuration which may be set a priori. The feedback template configuration may have a structure, format, syntax and semantic which are defined in a specification known a-priori by a gNB and a UE, for example, it may be comprised of one or more IEs as currently used in the RRC configurations or using a structure such as used in Uplink Control Information (UCI). The message space and meaning may be adapted on the fly and it may contain different scaling of values, different selection of values and different digital representations. For example, in case 5 bits are available, a bit space for the message and the feedback configuration template, also referred to as FBT (feedback template), defines 32 values to be measured, like the SNR. The measurement range and the number of measurements per message need to fit into 32 values.

In accordance with embodiments, advanced feedback loops may be implemented using the FBTs by exposing, requesting, concluding, changing or negotiating capabilities associated with the FBT initially before entering any further steps. Assuming a common understanding of the structure, format, syntax and semantics of the FBT, one end of the feedback loop, for example the gNB or network side, may create one or more FBTs or template configurations to be sent to the other end of the feedback loop, for example, the UE, using any kind of control or data channel, for example using the RRC layer or as data piggybacked on a data channel or over the top.

The receiving end or UE receives and decodes the transmitted configuration template or FBT and, if an acknowledgement/non-acknowledgement, ACK/NACK, or the like is foreseen, the UE may confirm a successful receipt of the configuration template. In case two or more templates or FBTs are provided, the UE may evaluate each configuration template against its capabilities, local situation and the like, and provide the acknowledgement/non-acknowledgement with an identifier which templates may be used at the UE's side. The UE may indicate that none of the templates is suitable so that, responsive to a corresponding signaling, the gNB may send a different set of one or more templates to be used by UE 400. The gNB, responsive to a confirmation of a particular template, sends an activation message to the UE to configure the particular template or FBT to be used in future by the UE. In case of a non-acknowledgement, the gNB may provide one or more other templates or FBTs to the UE for testing their suitability for the feedback situation at hand so that, eventually, some kind of negotiation procedure is initiated between the UE and the gNB to find a commonly supported template serving a desired purpose, like a link feedback. Although the above has been given with regard to the feedback loop between the gNB and the UE, it is noted that it may also be used for templates associated with other operations/functions to be performed by the UE.

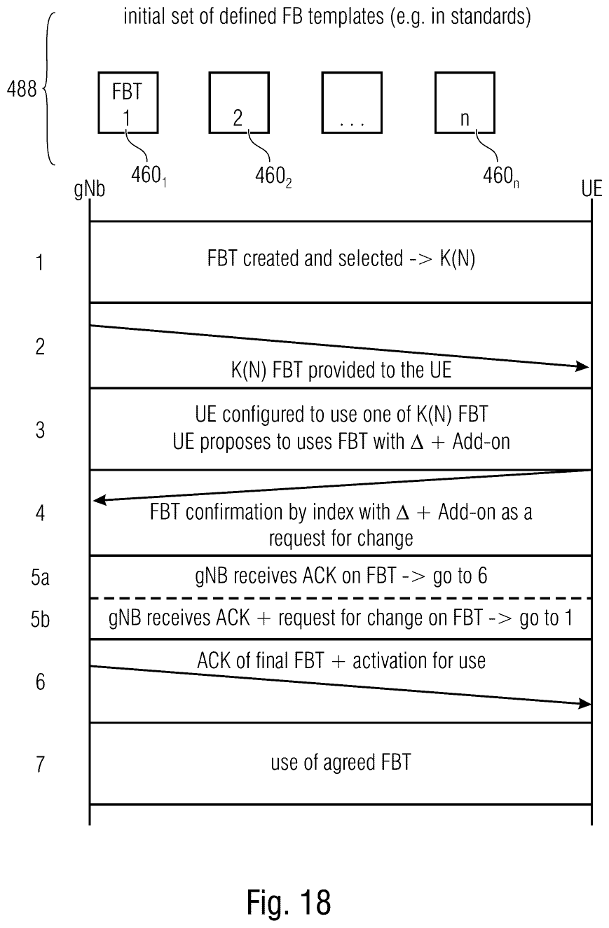

FIG. 18 illustrates the above-summarized functionality considering a communication between a gNB 410 and a UE 400 of FIG. 11 in accordance with the second aspect of the present invention. As is indicated at 488, a plurality of templates, like feedback templates or feedback template configurations 460₁ to 460ₙ is defined, for example in the standard, and gNB 410 creates a set K (N) of templates as is indicated at “1” and sends the set of templates to UE 400 as indicated at “2”. As it is indicated at “3”, UE 400 is configured to use one or more of the templates and may also propose changes to a template. For example, the RRCReconfigurationComplete message by a UE may include a field or fields and the corresponding value(s), changed compared to what was provided in the original template. Such changes may be limited only to certain fields, and may include a cause code as to indicate to, e.g., the gNB why a change was entailed. A UE may be pre-configured with a range of permitted fields and values. Once the configuration at the UE 400 has been completed, as is indicated at “4”, a confirmation is sent from UE 400 to the gNB 410 indicating which of the templates included in the set K (N) has been accepted and, optionally the changes to the template are signaled to the gNB 410. In case the gNB 410, as is indicated at “5a”, receives an acknowledgement regarding one or more of the templates or FBTs, it sends to the UE 400 an acknowledgement and activates the template, as is indicated at “6”. Further, as is indicated at “7”, UE 400 starts using the confirmed templates. In case it is indicate that one of the templates is not confirmed, as is shown at “5b”, gNB returns to “1” to create a new set of FBTs to be checked by the UE 400.

The advantage of the inventive approach in accordance with the second aspect of the present invention is the flexibility in the configuration of a certain operation or function to be performed by the UE 400, like a closed-loop feedback which includes a selection of KPIs, associated parameters, value range and the like. The template configuration approach allows the provision of various templates or FBTs at a time and an educated selection process including the receiver or UE which provides feedback as to the usage of a FBT or template. This allows for an increased flexibility in the configuration process and for an in-situ testing of different configurations, like different feedback mechanisms. Also, this allows for a mixed feedback provided by devices with different capabilities or being located in different wireless conditions.

With regard to the above-mentioned negotiation between the gNB and the UE so as to determine one or more templates to be used by the UE 400, in accordance with further embodiments, either end of the connection, i.e., the UE or the gNB may provide further information describing, for example, one or more of the following:
Combinations of a minimum of two original templates to be combined.
The derivation of one of the original template by a “delta”. When describing the new template to deviate from an previously used template by a delta, the delta represents a difference, e.g., in one or more of the following:
   a content or meaning of fields/parameters,
   a different order of fields, e.g., an order in which these values, fields are to be processed or weighted,
a change in distribution of, e.g., resolution bits across fields and values,
   an amount of fields/parameters in particular if the number of fields is reduced.
The derivation of more than one of the original templates by a “Delta 1”, . . . , “Delta K”. When describing several new templates to deviate from previously used templates by delta_1 to delta_k, the delta_i represents a similar difference like described above, but each delta_i being a difference/deviation from a particular template_i (old) to a template_i (new).
Additional parameters, tasks, values and the like to be included beyond the original template by an add-on. When describing the new template to deviate from an previously used template by an add-on, the add-on represents, e.g., one or more of the following:
   An additional field, compared to the previous template,
      the additional field being, e.g.,
         a new parameter or string of parameters, and/or
         a new metric derived from a combination/as a function of parameters/values which is beyond post processing of all other parameters.
   A description/meaning of a new field or redefinition of a field, when not known/defined before.
Any combination of the above.

In accordance to consistency the reduction of fields/parameters within a template has to be covered as well, advantageously within the delta description mechanism, since leaving away a field/parameter is rather self-explaining since the meaning of the parameter was known before.

Changes of the template may be based on descriptions referring to the members or IEs of an original template, and the changes may be informed, configured or advertised by the gNB or the UE or may be requested, suggested, demanded by the UE or the gNB. Previous examples have depicted how changes to a template may refer to changing field values, a range of possible field values and how they refer to combining fields/values from various templates. Conventionally, changes to the configuration are given as instructions to a UE by a gNB, to which the UE responds with, e.g., the RRCReconfigurationComplete message. The acknowledgment message by a UE, for example, the RRCReconfigurationComplete message, contains only a very few fields, apart from the available measurements that may or may not be provided to the gNB. The message, in principle, confirms that a UE has applied the new configuration or it has understood that a new configuration is to be applied when a condition is met. However, with UEs having a greater processing power and being able to act more autonomously, there is a benefit at a receiving side, namely, a UE, determining its configuration in a substantive way. Hence, such a UE may decide on a suitable configuration of a number of parameters, based on some conditions, internal or external to the UE. In order to guide the UE in this process, a set of conditions may be provided by the gNB, along with the fields/parameters that may be changed based on conditions. Examples of conditions internal to the UE may include, e.g., reaching a threshold on battery level or memory/CPU usage, a buffer status, an overheating and the like. External conditions may incorporate a number of parameters such as a low received reference signal power or a high interference, and the like. The changed IEs may, for example, include:
cell-level, beam level and CSI measurement and reporting related IEs, specifying a change in reporting quantity, measurement granularity, measurement resources, power-levels associated with reporting, etc., a change in the DL or UL BWP or an additional DL or UL BWP, its subcarrier spacing and a cyclic prefix configuration,
a DRX configuration,
a scheduling request configuration,
a change in the UE's configuration of MIMO layers, antenna and codebook configuration,
a change in any of the above or other appropriate parameters in any of the serving cells (CA or DC) etc.

Furthermore, such a mode of operation may be applicable to, e.g., certain areas or may be explicitly activated by the network to avoid long signaling exchanges. Also, future UEs may incorporate sensing functionality that enables them to detect fixed and moving obstacles, pedestrians or, more generally, their environment, which makes UE-based configuration determination even more prevalent. To conclude, changes proposed by, e.g., a gNB, may be confirmed, acknowledged, selected, accepted or rejected, non-acknowledged, barred or deselected by the receiving side, i.e. the UE, or may be conditionally accepted/selected or partially accepted/selected or modified so as to cause sending a new template for further processing or modified and re-sent for use.

The advantage of the above-described embodiment is that an even further flexibility in configuring a certain operation or function, like a closed feedback loop, is achieved, including the creating of a new template which may be retraced to an existing base template originally defined in a specification known to the gNB and the UE. This embodiment allows to adapt a configuration, like a feedback structure, with regard to, e.g., the format, syntax, semantics of a report message and reduce the size and structure of feedback messages to be adapted to a situation and duration of use.

An example of a feedback scheme may be the following: A UE is providing a transmit or receive beam and a report, how this beam is created, also known as a design base provided/reported. Within this design base a number of beam identifiers may be reported, wherein the beam identifiers refer to specific beams and their associated reference signals which were considered in the computation of the transmit/receive beam and therefore form a design base for it. Furthermore, the order of the indices may indicate a certain order of, e.g., receive signal strength per design base component, wherein such indication may come from some prior agreements described by a syntax. Furthermore, a specific number of indices below a maximum number may indicate that these components are within a certain range, e.g., within 10 dB of difference between the largest and smallest component provided. Such indication again may be according to another syntax described or agreed before. Besides indices, more specific values describing the design base components may be used including specific formats, e.g., “index+ordering index” or “index+receive signal strength” normalized or not normalized to a specific value. The expression of the semantics may also be contained with the report referring, e.g., to previously used design bases (cross-references) or describing a certain time of usage, e.g., “until further notice” or “one more time”. Combining flexible fields, actions and values therein with configurable formats, syntax and semantics allows to describe new ways of feedback reports, configurations, etc. starting from a base set of templates and deriving more complex templates in an evolutionary fashion.

In particular, the flexible adaption of message lengths and content allows to convey further information with the messages than originally intended by the original template. This may include requests, proposals, instructions for further educated decision making and further refinement of the template to be applied in a closed loop communication. Provided that a template is used for a sufficient period of time, for example, when considering a static connection between the gNB and a particular UE serving as a hotspot or aggregation point with a particular service requirement, a further duration of the template may be beneficial in terms of achievable degree of optimization and feedback overhead and effectiveness. In other situations, in which channel conditions, service requirements and the like are changing rapidly, improvements of the template may be terminated after a configurable number of iterations.

### Embodiments Pertaining the First and Second Aspects

So far, first and second aspects have been described in detail. In the following, further embodiments are described which apply equally to the first and second aspects.

In accordance with embodiments, UE 400 may be configured with the one or more configurations/configuration templates during operation of the network using, e.g., RRC signaling. In accordance with other embodiments, UE 400 may be preconfigured with the one or more configurations/configuration templates p. For example, UE 400 may be provided with a UE configuration/configuration template at a time of an initial connection with the network, for example via a signaling in the RRC layer of the protocol stack of the wireless communication system. A UE may also be provided with a UE configuration/configuration template, i.e., may be preconfigured with the UE configuration, at a time of provisioning the UE for operation with a certain wireless communication network, for example by inserting an appropriate subscriber identity module, SIM, or by activating an embedded SIM, eSIM, holding the UE configuration/configuration template. The UE may also be preconfigured with the UE configuration at the time of manufacturing the UE, for example, by storing the UE configuration/configuration template in a memory of the UE, like an eSIM or in any other memory element of the UE.

In the above-described embodiments reference has been made to certain criteria that the UE 400 may apply so as to determine on its own whether and how a certain configuration/configuration template is to be modified/populated or how a new configuration/new configuration templates is to be created using two or more of a plurality of existing UE configurations/configuration templates. In accordance with embodiments, the one or more criteria may comprise one or more of the following:
one or more events, like a handover, HO, or a conditional handover, CHO, of the UE from a source base station to a target base station, where a UE determines that its configuration related to, e.g., a MIMO configuration, measurement and reporting, connected-mode DRX, or any other configuration related to a new cell needs to be modified/populated to better match the UE's observed environment,
change of a beam or of one of the TRPs,
a control information signal reception, indicating a change in spatial and other QCL-relations in the DL reference signals,
a reference signal RSRP/RSRQ/SINR of a serving cell/beam falls below a predefined threshold and/or a neighbor cell/beam RSRP/RSRQ/SINR exceeds a predefined threshold,
an interference on a specified resource of a serving cell/beam exceeds a predefined threshold,
one or more events internal to the UE, such as
   a battery level falls below a predefined threshold, or
   a memory/CPU usage reaches a predefined threshold, or
   a buffer status exceeds a predefined threshold,
   overheating.

In accordance with embodiments described above, the modification/population of an existing configuration/configuration template or the generation of a new configuration/new configuration template using two or more existing configurations/configuration templates occur responsive to the receipt of the one or more control messages. In accordance with further embodiments, UE 400 may perform the actions entailed either responsive to the receipt of the control message, i.e., once the UE 400 decoded the control message and determined that it holds the respective information for the modification/population/combination for the UE, it starts immediately after decoding with the respective information. In accordance with other embodiments, UE 400 may receive the control message, however, starts only with the modification/populating/generation at a predefined time, for example, after lapse of a time period after receipt of the control message or at an explicit point of time that was signaled in the control message. In accordance with yet other embodiments, UE 400 may perform the modification/populating/creation only once one or more predefined conditions are, as described in more detail above with reference to the second aspect of the present invention.

In accordance with further embodiments, once the UE completes the modification/populating/generation or the combination of existing configurations/configuration templates into a new configuration, UE 400 may inform other network entities, for example gNB 410 and sidelink UE 420 about the new configuration/configuration template, for example by sending one or more report messages including a description of the new configuration/configuration template indicating the fields modified/populated in the configuration/configuration template and the one or more new field values associated with the fields, or a general description of the new configuration/configuration template created on the basis of several existing configurations/configuration templates.

In accordance with yet further embodiments, once the UE completed the new configuration, it may start to operate or function in accordance with the new configuration. For example, the UE may operate in accordance with the new configuration at a predefined time and/or until one or more conditions are met. The conditions may include one or more of the conditions described in more detail above with reference to the second aspect of the present invention.

Thus, the UE may start operating in accordance with the new configuration after a predefined time expires and/or until one or more of the following conditions are met, like
a deactivation of the currently used configuration,
a certain event, which was predefined as a condition, e.g., when a battery threshold is passed,
a certain trigger, like a signal received or a trigger derived from one or more conditions met in a certain functional relationship e.g. XOR, AND. For example a report about the design base of a beamformer is changed to use transmitted signals from the serving gNB only in a low interference situation, while in a high interference situation interference sources like other gNBs might be considered. More concretely, if the SNR, SIR are high then the design base may be chosen to support maximum multiplexing with an optimal match between transmit and receive beamformers. In case of high SNR but medium or low SIR the design base includes at least the significant interferers and the optimization will be towards a robust SINR with a reasonable number of streams to be supported. Therefore a weighted combination and/or IF THEN decisions may create a trigger from several conditions met in a functional relationship.

In case of operating for a predefined time, UE 400 may operate or function in accordance with the new configuration until a certain timer has lapsed, the setting of the timer being indicated, for example, also in the control message associated with creating the new configuration, or until a certain point in time also indicated in the control message.

In accordance with yet other embodiments, the UE 400 may start operating or functioning in accordance with the new configuration after a predefined time or once one or more conditions are met, for example a deactivation of a currently used configuration by the UE 400 or responsive to a certain event or trigger, like those described in more detail above with reference to the second aspect of the present invention.

In accordance with other embodiments, UE 400 may maintain the current configuration as a default or old configuration, and once the new configuration is no longer to be used and no other configuration is indicated to be used, UE 400 may fall back to the use of the default or old configuration.

In accordance with further embodiments of the first and second aspects of the present invention, UE 400 may receive from one or more of the entities of the wireless communication system an activation signal or activation condition concerning the use of the new configuration or the new configuration template. UE 400, after having created the new configuration or new configuration template is to use it only responsive to the activation signaling or to the activation condition. Further, in accordance with embodiments, in case UE 400 receives the control messages causing it to create the new configuration/new configuration template, UE 400 signals, for example via the Uu interface 418 or the PC5 interface 422 the completion of the creating of the configuration/new configuration template.

In accordance with embodiments, the field values of the fields to be modified or to be populated may be one or more of the following:
a certain value for a parameter specified by the field,
a resolution of a value in terms of a certain unit value, e.g. xx digits before and/or after comma
a reference to another configuration for the UE,
a procedural command describing an operation on values described in fields,
a concatenation order of commands.

In accordance with embodiments, UE 400 may be provided to perform one or more of the following operations or functions using the configuration or configuration templates provided in accordance with the above-described embodiments of the first and second aspects:
a communication, like a transmission and/or a reception of data, with to one or more entities of the wireless communication system,
a measurement of the radio environment and reporting of the measurements to one or more entities of the wireless communication system,
configuration/change of PHY and/or higher layer for transmissions and/or reception
a feedback to be provided by the UE to one or more entities of the wireless communication system.

For the transmission and/or a reception of data, the UE is configured by one or more of the following configurations or configuration templates:
a serving beam/cell configuration or configuration template, including beam failure recovery, Secondary Cell, SCell, and Primary SCell, PSCell, configurations or configuration templates,
a configuration or configuration template for a bandwidth part of any serving cell,
a configuration or configuration template for a slot format,
a configuration or configuration template for a codebook configuration,
a configuration or configuration template for a Discontinuous Reception, DRX, configuration,
a configuration or configuration template for a uplink/downlink, UL/DL, scheduling configuration,
a configuration or configuration template for an antenna/antenna port configuration.
a configuration or configuration template for a Demodulation Reference Signal, DMRS, configuration,
a configuration or configuration template for a configured grant configuration,
a configuration or configuration template for a data radio bearer configuration,
a configuration or configuration template for any PHY, MAC and higher layer configuration used for transmission and/or reception of data,

For the measurement of the radio environment, the UE is configured by one or more of the following configurations or configuration templates:
a configuration or configuration template for a Synchronization Signal Block, SSB,
a configuration or configuration template for a Zero Power and Non-Zero Power Channel-State Information Reference Signals, CSI-RS,
a configuration or configuration template for CSI Interference Measurement Reference Signals, CSI-IM RS,
a configuration or configuration template for a phase tracking reference signal,
a configuration or configuration template for a sounding reference signal,
a configuration or configuration template for any reference signal,
a configuration or configuration template for Quasi co-location, QCL, information between different reference signals,
a configuration or configuration template for a measurement gap configuration,
a configuration or configuration template for measurement quantities per beam/cell, metrics,
a configuration or configuration template for measurement events, conditions and/or thresholds for layer 1, L1, and/or layer 3, L3, measurements,

For the feedback, the UE is configured by one or more of the following configurations or configuration templates:
a configuration or configuration template for a time and frequency configuration of reporting, as well as sub-carrier spacing,
a configuration or configuration template for defined reference signals,
a configuration or configuration template for a group beam based reporting,
a configuration or configuration template for a type of report-wide-band or sub-band,
a configuration or configuration template for a Channel Quality Indicator/Rank Indicator/Precoding Matrix Indicator, CQI/RI/PMI, mode,
a configuration or configuration template for a codebook type,
a configuration or configuration template for measurement filtering rules.

In accordance with embodiments, the wireless communication system with a 3GPP system, the configuration is an RRC configuration, the protocol stack is the NR protocol stack, the first layer is the RRC layer and the one or more second layers comprise one or both of the MAC layer and the PHY layer, and the control message comprises a DCI or a MAC CE or both. The fields of the configuration template may be information elements including respective IE fields and each IE field has one or more field values to be applied are used by the UE when performing the certain operation or function.

### Radio Access Network Entity

Embodiments of the first and second aspects of the present invention provide a network entity for a wireless communication or system, like a radio access network entity, for example a base station or gNB or another UE. For example, as illustrated in FIG. 11, the network entity may be a gNB 410 or a sidelink UE 420 as described above with reference to FIG. 11. The following embodiments are described with reference to the gNB 410, however, they may also be implemented in the sidelink UE 420.

In accordance with embodiments of the first aspect of the present invention, the gNB 410 may provide the above-described one or more control messages to UE 400 over the Uu interface 418, and the control message may include, in accordance with the first embodiments of the first aspect, for one or more fields of a UE configuration 408 in UE 400 respective field values to be used to allow UE 400 to obtain a new UE configuration by replacing a field value with a new field value. In accordance with the second embodiments of the first aspect, the control message may include information for generating the new configuration using two or more of the existing UE configurations 408 at UE 400.

With regard to the second aspect of the present invention, gNB 410, in accordance with the first embodiment of the second aspect, may provide the control message including the field values for populating the placeholders of a configuration template 460 at UE 400. With regard to the second embodiment of the second aspect, the control message may include the information allowing UE 400 to generate a new configuration template using the existing templates 460.

The gNB 410 may send the control message on a first layer of the protocol stack also used for transmitting the configuration messages, like the RRC layer, with the control message being a configuration message of smaller size than a configuration message carrying the actual configuration/configuration template when configuring/preconfiguring UE 400 with the configurations 408/configuration templates 460. In accordance with other embodiments, the control message may be provided on a lower layer of the protocol stack, for example using L1 signaling in the PHY layer or L2 signaling in the MAC, PDCP layer.

In accordance with further embodiments, the gNB 410 may signal also information about when the new configuration/new configuration template is to be used by UE 400, like an activation signal.

### General

In accordance with the present invention, an approach is described which allows speeding up a configuration using lightweight signaling mechanisms, such as configuration messages with reduced size or a DCI which is enabled by using a template based configuration. This allows a more flexible approach for configuring a UE for performing certain operations and reduces for example RRC signaling in situations in which a certain number of UEs uses a similar configuration and only few of the UE need changes in the configuration which may be implemented in accordance with the embodiments of the first aspect of the present invention.

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and entailing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

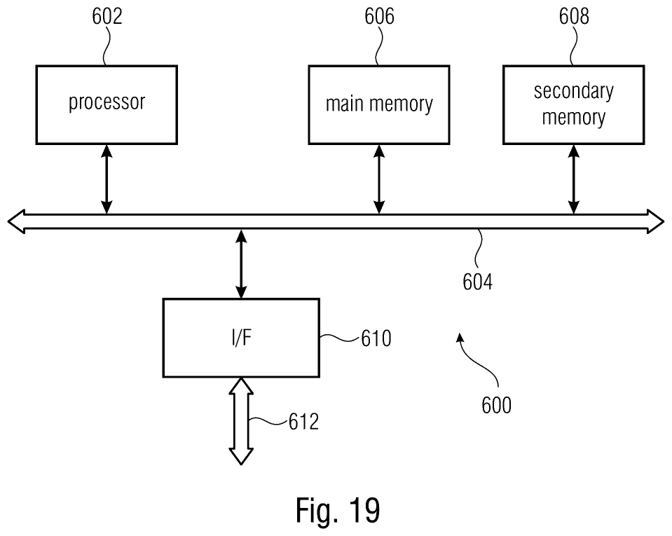

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 19 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication system, like a 3rd Generation Partnership Project, 3GPP, system, the UE comprising:
one or more antennas,
a signal processor connected to the antenna, and
one or more configurations,
wherein the configuration
is associated with one or more certain operations to be performed by the signal processor,
defines one or more fields concerning the certain operation, and
comprises for each field one or more field values to be applied or used by the UE when performing the certain operation,
wherein the UE is to operate in accordance with the configuration, and
wherein the UE is to generate a new configuration by modifying the configuration by replacing the field value for a field in the configuration by a new field value.

2. The user device, UE, of claim 1, wherein the UE is to modify the configuration for acquiring a new configuration
responsive to one or more control messages, the control message comprising for one or more or all of the fields of the configuration one or more new field values, or
responsive to one or more criteria, wherein the UE is to select for one or more or all of the fields of the configuration one or more new field values in accordance with the one or more criteria.

3. The user device, UE, of claim 1, wherein the UE is to report the new configuration to one or more network entities using, e.g., one or more report messages comprising a description of the new configuration indicating the fields modified in the configuration and the one or more new field values associated with the modified fields.

4. The user device, UE, of claim 1, wherein the UE is to operate in accordance with the new configuration, and
wherein the UE is to operate in accordance with the new configuration for a predefined time and/or until one or more of the following conditions are met:
an activation of a different configuration from the one or more configurations,
a certain event or trigger occurs, such as a cell, a beam or a TRP change, or a control information signal reception indicating a change in spatial and other QCL-relations in DL reference signals, causing a change in
a cell-level, a beam level and a CSI measurement and reporting, specifying a change in reporting quantity, measurement granularity, measurement resources, power-levels associated with reporting, etc.,
a DL or UL BWP, its subcarrier spacing and cyclic prefix configuration,
the UE's configuration of MIMO layers, antenna and codebook configuration,
a DRX configuration,
any of the above or other appropriate parameters in any of the serving cells,
one or more certain other events or triggers, like a reference signal RSRP/RSRQ/SINR of a serving cell/beam falling below a predefined threshold and/or a neighbor cell/beam reference signal RSRP/RSRQ/SINR exceeding a predefined threshold, or an interference level on a specified resource of a serving cell/beam exceeding or falling below a predefined threshold, causing the UE to, e.g., change a cell-level, a beam level and a CSI measurement and reporting, specifying a change in reporting quantity, measurement granularity, measurement resources,
one or more events or triggers internal to the UE, causing the UE to modify, e.g., a DRX configuration, or a power level and frequency and granularity of cell or beam and CSI measurement and reporting, a scheduling requests configuration, a change in the UE's configuration of MIMO layers and antenna configuration, a change or deactivation of CA or DC cells, specific events or triggers such as
a battery level falls below a predefined threshold,
a memory or CPU usage reaches a predefined threshold,
a buffer exceeds a predefined threshold,
an overheating.

5. The user device, UE, of claim 1, wherein the UE is preconfigured with the configuration
at a time of initial connection with the wireless communication system, e.g., via a signaling in the first layer of a protocol stack of the wireless communication system,
at a time of provisioning the UE for operation with the wireless communication system, e.g., by inserting a Subscriber Identity Module, SIM, holding the configuration or the configuration template or by activating an embedded SIM, eSIM, holding the configuration or the configuration template, or
at a time of manufacturing the UE, e.g., by storing the configuration or the configuration template in a memory of the UE, like in an eSIM or in any other memory element.

6. A user device, UE, for a wireless communication system, like a 3rd Generation Partnership Project, 3GPP, system, the UE comprising:
one or more antennas,
a signal processor connected to the antenna, and
one or more configuration templates,
wherein the configuration template
is associated with one or more certain operations to be performed by the signal processor,
defines one or more fields concerning the certain operation, and
comprises for one, some or all fields a placeholder for one or more field values,
wherein the UE is to generate a configuration for performing the certain operation by replacing in the configuration template the placeholder for a field by a field value.

7. The user device, UE, of claim 6, wherein the UE is to replace a placeholder for a field by a field value
responsive to one or more control messages, the control message comprising for one or more or all of the fields of the configuration template one or more field values, or
responsive to one or more criteria, wherein the UE is to select for one or more or all of the fields of the configuration template one or more field values in accordance with the one or more criteria.

8. The user device, UE, of claim 6, wherein, for generating the configuration, the UE is to copy the configuration template and replace in the copied configuration template the placeholder for a field by a field value from the control message, thereby generating the configuration for performing the certain operation and maintaining the original configuration template.

9. The user device, UE, of claim 6, wherein the UE is to operate in accordance with the generated configuration.

10. The user device, UE, of claim 6, wherein the UE is to report the generated configuration to one or more network entities using, e.g., one or more report messages comprising a description of the generated configuration indicating the fields in the generated configuration and the one or more new field values associated with the fields.

11. The user device, UE, of claim 6, wherein the UE is to
modify the generated configuration by replacing the field value for a field in the generated configuration by a new field value, and
operate in accordance with the new configuration.

12. The user device, UE, of claim 1, wherein
the UE is to receive from one or more entities of the wireless communication system, like a base station or another UE, an activation signal or activation condition of the new configuration/new configuration template, and
the UE is to make use of the new configuration/new configuration template only responsive to the activation signaling or activation condition.

13. The user device, UE, of claim 1, wherein
the UE is to receive the one or more control messages/further control signals from one or more entities of the wireless communication system, like a base station or another UE, and
the UE is to signal a completion of creating a configuration/new configuration template, e.g., to the entity of the wireless communication system that provided the control message.

14. The user device, UE, of claim 1, wherein the field value for a field in a configuration comprises one or more of:
a certain value for a parameter specified by the field,
a resolution of a value in terms of a certain unit value, e.g. xx digits before and/or after comma
a reference to another configuration for the UE,
a procedural command describing an operation on values described in fields,
a concatenation order of commands.

15. The user device, UE, of claim 1, wherein the certain operation incudes one or more of the following:
a communication, like a transmission and/or a reception of data, with to one or more entities of the wireless communication system,
a measurement of the radio environment and reporting of the measurements to one or more entities of the wireless communication system,
configuration/change of PHY and/or higher layer for transmissions and/or reception
a feedback to be provided by the UE to one or more entities of the wireless communication system.

16. The user device, UE, of claim 1, wherein
the wireless communication system is a 3rd Generation Partnership Project, 3GPP, system,
the configuration is a Radio Resource Control, RRC, configuration,
the protocol stack is the 5G, New Radio, NR, Radio Protocol Stack,
the first layer is the 5G RRC layer of the 5G NR Radio Protocol Stack,
the one or more second layers comprises one or both of the 5G MAC layer and the 5G PHY layer of the 5G NR Radio Protocol Stack, and
the control message comprises a DCI or a MAC CE or both.

17. The user device, UE, of claim 16, wherein the RRC configuration or the configuration template comprises one or more fields, which are defined using information elements, IEs, each IE comprises one or more IE fields, and each IE field comprises one or more field values to be applied or used by the UE when performing the certain operation.

18. The user device, UE, of claim 1, wherein the UE is preconfigured with the configuration or the configuration template
at a time of initial connection with the wireless communication system, e.g., via a signaling in the first layer of a protocol stack of the wireless communication system,
at a time of provisioning the UE for operation with the wireless communication system, e.g., by inserting a Subscriber Identity Module, SIM, holding the configuration or the configuration template or by activating an embedded SIM, eSIM, holding the configuration or the configuration template, or
at a time of manufacturing the UE, e.g., by storing the configuration or the configuration template in a memory of the UE, like in an eSIM or in any other memory element.

19. A method for operating a user device, UE, for a wireless communication system, like a 3^{rd} Generation Partnership Project, 3GPP, system, the UE comprising one or more antennas, a signal processor connected to the antenna, and one or more configurations,
wherein the configuration
is associated with one or more certain operations to be performed by the signal processor,
defines one or more fields concerning the certain operation, and
comprises for each field one or more field values to be applied or used by the UE when performing the certain operation,
wherein the method comprises:
operating the UE in accordance with the configuration, and
generating, by the UE, a new configuration by modifying the configuration by replacing the field value for a field in the configuration by a new field value.

20. A method for operating a user device, UE, for a wireless communication system, like a 3^{rd} Generation Partnership Project, 3GPP, system, the UE comprising one or more antennas, a signal processor connected to the antenna, and one or more configuration templates, wherein the configuration template
is associated with one or more certain operations to be performed by the signal processor,
defines one or more fields concerning the certain operation, and
comprises for one, some or all fields a placeholder for one or more field values,
wherein the method comprises:
generating, by the UE, a configuration for performing the certain operation by replacing in the configuration template the placeholder for a field by a field value.
